(19) United States
(12) Patent Application Publication
(10) Pub. No.: US 2004/0151327 A1
(43) Pub. Date: Aug. 5, 2004

(54) Audio device integration system

(76) Inventor: Ira Marlow, Fort Lee, NJ (US)

Correspondence Address: Wolff & Samson PC, One Boland Drive, West Orange, NJ, 07052, US

(21) Appl. No.: 10/732,909

(22) Filed: Dec. 10, 2003

Related U.S. Application Data
(63) Continuation-in-part of application No. 10/316,961, filed on Dec. 11, 2002.
(60) Provisional application No. 60/523,714, filed on Nov. 20, 2003.

(51) Int. Cl. H04B 1/00; H04R 1/02

(52) U.S. Cl. 381/86; 381/389

(57) ABSTRACT

An audio device integration system is provided. One or more after-market audio devices, such as a CD player, CD changer, MP3 player, satellite receiver, DAB receiver, or the like, is integrated for use with an existing OEM or after-market car stereo system, wherein control commands can be issued at the car stereo and responsive data from the audio device can be displayed on the stereo. Control commands generated at the car stereo are received, processed, converted into a format recognizable by the audio device, and dispatched to the audio device for execution. Information from the audio device, including track, disc, song, station, time, and other information, is received, processed, converted into a format recognizable by the car stereo, and dispatched to the car stereo for display thereon. One or more auxiliary input sources can be integrated with the car stereo, and selected between using the controls of the car stereo. Both an audio device and one or more auxiliary input sources can be integrated together, and a user can select between the device or the one or more auxiliary input sources by issuing selection commands through the car stereo. A docking station is provided for docking a portable audio or video device for integration with the car stereo.

### RELATED APPLICATIONS

This application is a continuation-in-part of U.S. patent application Ser. No. 10/316,961 filed Dec. 11, 2002 and claims the benefit of U.S. Provisional Application Serial No. 60/523,714 filed Nov. 20, 2003, the entire disclosures of which are both expressly incorporated herein by reference.

### BACKGROUND OF THE INVENTION

1. Field of the Invention

The present invention relates to an audio device integration system. More specifically, the present invention relates to an audio device integration system for integrating after-market components such as satellite receivers, CD players, CD changers, MP3 players, Digital Audio Broadcast (DAB) receivers, auxiliary audio sources, and the like with factory-installed (OEM) or after-market car stereo systems.

2. Related Art

Automobile audio systems have continued to advance in complexity and the number of options available to automobile purchasers. Early audio systems offered a simple AM and/or FM tuner, and perhaps an analog tape deck for allowing cassettes, 8-tracks, and other types of tapes to be played while driving. Such early systems were closed, in that external devices could not be easily integrated therewith.

With advances in digital technology, CD players have been included with automobile audio systems. Original Equipment Manufacturers (OEMs) often produce car stereos having CD players and/or changers for allowing CDs to be played while driving. However, such systems often include proprietary buses and protocols that do not allow after-market audio systems, such as satellite receivers (e.g., XM satellite tuners), digital audio broadcast (DAB) receivers, MP3 players, CD changers, auxiliary input sources, and the like, to be easily integrated therewith. Thus, automobile purchasers are frequently forced to either entirely replace the OEM audio system, or use same throughout the life of the vehicle or the duration of ownership. Even if the OEM radio is replaced with an after-market radio, the after-market radio also frequently is not operable with an external device.

A particular problem with integrating after-market audio systems with existing car stereos is that signals generated by the car stereo is in a proprietary format, and is not capable of being processed by the after-market system. Additionally, signals generated by the after-market system are also in a proprietary format that is not recognizable by the car stereo. Thus, in order to integrate after-market systems with car stereos, it is necessary to convert signals between such systems.

It known in the art to provide one or more expansion modules for OEM and after-market car stereos for allowing external audio products to be integrated with the car stereo. However, such expansion modules only operate with and allow integration of external audio products manufactured by the same manufacturer as the OEM/after-market car stereo. For example, a satellite receiver manufactured by PIONEER, Inc., cannot be integrated with an OEM car radio manufactured by TOYOTA or an after-market car radio manufactured by CLARION, Inc. Thus, existing expansion modules only serve the limited purpose of integrating equipment by the same manufacturer as the car stereo. Thus, it would be desirable to provide an integration system that allows any audio device of any manufacture to be integrated with any OEM or after-market radio system.

Moreover, it would be desirable to provide an integration system that not only achieves integration of various audio devices that are alien to a given OEM or after-market stereo system, but also allows for information to be exchanged between the after-market device and the car stereo. For example, it would be desirable to provide a system wherein station, track, time, and song information can be retrieved from the after-market device, formatted, and transmitted to the car stereo for display thereby, such as at an LCD panel of the car stereo. Such information could be transmitted and displayed on both hardwired radio systems (e.g., radios installed in dashboards or at other locations within the car), or integrated for display on one or more software or graphically-driven radio systems operable with graphical display panels. Additionally, it would be desirable to provide an audio integration system that allows a user to control more than one device, such as a CD or satellite receiver and one or more auxiliary sources, and to quickly and conveniently switch between same using the existing controls of the car stereo.

Accordingly, the present invention addresses these needs by providing an audio integration system that allows a plurality of audio devices, such as CD players, CD changers, MP3 players, satellite receivers, DAB receivers, auxiliary input sources, or a combination thereof, to be integrated into existing car stereos while allowing information to be displayed on, and control to be provided from, the car stereo.

### SUMMARY OF THE INVENTION

The present invention relates to an audio device integration system. One or more after-market audio devices, such as a CD player, CD changer, MP3 player, satellite receiver (e.g., XM tuner), digital audio broadcast (DAB) receiver, or auxiliary input source, can be connected to and operate with an existing stereo system in an automobile, such as an OEM car stereo system or an after-market car stereo system installed in the automobile. The integration, system connects to and interacts with the car stereo at any available port of the car stereo, such as a CD input port, a satellite input, or other known type of connector. If the car stereo system is an after-market car stereo system, the present invention generates a signal that is sent to the car stereo to keep same in an operational state and responsive to external data and signals. Commands generated at the control panel are received by the present invention and converted into a format recognizable by the after-market audio device. The formatted commands are executed by the audio device, and audio therefrom is channeled to the car stereo. Information from the audio device is received by the present invention, converted into a format recognizable by the car stereo, and forwarded to the car stereo for display thereby. The formatted information could include information relating to a CD or MP3 track being played, channel, song, and artist information from a satellite receiver or DAB receiver, or video information from one or more external devices connected to the present invention. The information can be presented as one or more menus, textual, or graphical prompts for display on an LCD display of the radio, allowing interaction with the user at the radio. A docking port is provided for allowing portable external audio devices to be connected to the interface of the present invention.

In an embodiment of the present invention, a dual-input device is provided for integrating both an external audio device and an auxiliary input with an OEM or after-market car stereo. The user can select between the external audio device and the auxiliary input using the controls of the car stereo. The invention can automatically detect the type of device connected to the auxiliary input, and integrate same with the car stereo.

In another embodiment of the present invention, an interface is provided for integrating a plurality of auxiliary input sources with an existing car stereo system. A user can select between the auxiliary sources using the control panel of the car stereo. One or more after-market audio devices can be integrated with the auxiliary input sources, and a user can switch between the audio device and the auxiliary input sources using the car stereo. Devices connected to the auxiliary input sources are inter-operable with the car stereo, and are capable of exchanging commands and data via the interface.

### BRIEF DESCRIPTION OF THE DRAWINGS

These and other important objects and features of the invention will be apparent from the following Detailed Description of the Invention, taken in connection with the accompanying drawings, in which:

FIG. 1 is a block diagram showing the audio device integration system of the present invention.

FIG. 2a is a block diagram showing an alternate embodiment of the audio device integration system of the present invention, wherein a CD player is integrated with a car radio.

FIG. 2b is a block diagram showing an alternate embodiment of the audio device integration system of the present invention, wherein a MP3 player is integrated with a car radio.

FIG. 2c is a block diagram showing an alternate embodiment of the audio device integration system of the present invention, wherein a satellite or DAB receiver is integrated with a car radio.

FIG. 2d is a block diagram showing an alternate embodiment of the audio device integration system of the present invention, wherein a plurality of auxiliary input sources are integrated with a car radio.

FIG. 2e is a block diagram showing an alternate embodiment of the audio device integration system of the present invention, wherein a CD player and a plurality of auxiliary input sources are integrated with a car radio.

FIG. 2f is a block diagram showing an alternate embodiment of the present invention, wherein a satellite or DAB receiver and a plurality of auxiliary input source are integrated with a car radio.

FIG. 2g is a block diagram showing an alternate embodiment of the present invention, wherein a MP3 player and a plurality of auxiliary input sources are integrated with a car radio.

FIG. 2h is a block diagram showing an alternate embodiment of the present invention, wherein a plurality of auxiliary interfaces and an audio device are integrated with a car stereo.

FIG. 3a is a circuit diagram showing a device according to the present invention for integrating a CD player or an auxiliary input source with a car radio.

FIG. 3b is a circuit diagram showing a device according to the present invention for integrating both a CD player and an auxiliary input source with a car radio, wherein the CD player and the auxiliary input are switchable by a user.

FIG. 3c is a circuit diagram showing a device according to the present invention for integrating a plurality of auxiliary input sources with a car radio.

FIG. 3d is a circuit diagram showing a device according to the present invention for integrating a satellite or DAB receiver with a car radio.

FIG. 4a is a flowchart showing processing logic according to the present invention for integrating a CD player with a car radio.

FIG. 4b is a flowchart showing processing logic according to the present invention for integrating a MP3 player with a car radio.

FIG. 4c is a flowchart showing processing logic according to the present invention for integrating a satellite receiver with a car radio.

FIG. 4d is a flowchart showing processing logic according to the present invention for integrating a plurality of auxiliary input sources with a car radio.

FIG. 4e is a flowchart showing processing logic according to the present invention for integrating a CD player and one or more auxiliary input sources with a car radio.

FIG. 4f is a flowchart showing processing logic according to the present invention for integrating a satellite or DAB receiver and one or more auxiliary input sources with a car radio.

FIG. 4g is a flowchart showing processing logic according to the present invention for integrating a MP3 player and one or more auxiliary input sources with a car stereo.

FIG. 5 is a flowchart showing processing logic according to the present invention for allowing a user to switch between an after-market audio device and one or more auxiliary input sources.

FIG. 6 is a flowchart showing processing logic according to the present invention for determining and handling various device types connected to the auxiliary input ports of the invention.

FIG. 7a is a perspective view of a docking station according to the present invention for retaining an audio device within a car.

FIG. 7b is an end view of the docking station of FIG. 7a.

FIGS. 8a-8b are perspective views of another embodiment of the docking station of the present invention, which includes the audio device integration system of the present invention incorporated therewith.

FIG. 9 is a block diagram showing the components of the docking station of FIGS. 8a-8b.

### DETAILED DESCRIPTION OF THE INVENTION

The present invention relates to an audio device integration system. One or more after-market audio devices, such as a CD player, CD changer, MP3 player, satellite receiver, digital audio broadcast (DAB) receiver, or the like, can be integrated with an existing car radio, such as an OEM car stereo or an after-market car stereo. Control of the audio device is enabled using the car radio, and information from the audio device, such as channel, artist, track, time, and song information, is retrieved form the audio device, processed, and forwarded to the car radio for display thereon. The information channeled to the car radio can include video from the external device, as well as graphical and menu-based information. A user can review and interact with information via the car stereo. Commands from the car radio are received, processed by the present invention into a format recognizable by the audio device, and transmitted thereto for execution. One or more auxiliary input channels can be integrated by the present invention with the car radio. The user can switch between one or more audio devices and one or more auxiliary input channels using the control panel buttons of the car radio.

As used herein, the term “integration” or “integrated” is intended to mean connecting one or more external devices or inputs to an existing car radio or stereo via an interface, processing and handling signals and audio channels, allowing a user to control the devices via the car stereo, and displaying data from the devices on the radio. Thus, for example, integration of a CD player with a car stereo system allows for the CD player to be remotely controlled via the control panel of the stereo system, and data from the CD player to be sent to the display of the stereo. Of course, control of audio devices can be provided at locations other than the control panel of the radio without departing from the spirit or scope of the present invention. Further, as used herein, the term “inter-operable” is intended to mean allowing the external audio device to receive and process commands that have been formatted by the interface of the present invention, as well as allowing a car stereo to display information that is generated by the external audio device and processed by the present invention. Additionally, by the term “inter-operable,” it is meant allowing a device that is alien to the environment of an existing OEM or after-market car stereo to be utilized thereby.

Also, as used herein, the terms “car stereo” and “car radio” are used interchangeably and are intended to include all presently existing car stereos and radios, such as physical devices that are present at any location within a vehicle, in addition to software and/or graphically- or display-driven receivers. An example of such a receiver is a software-driven receiver that operates on a universal LCD panel within a vehicle and is operable by a user via a graphical user interface displayed on the universal LCD panel. Further, any future receiver, whether a hardwired or a software/graphical receiver operable on one or more displays, is considered within the definition of the terms “car stereo” and “car radio,” as used herein, and is within the spirit and scope of the present invention.

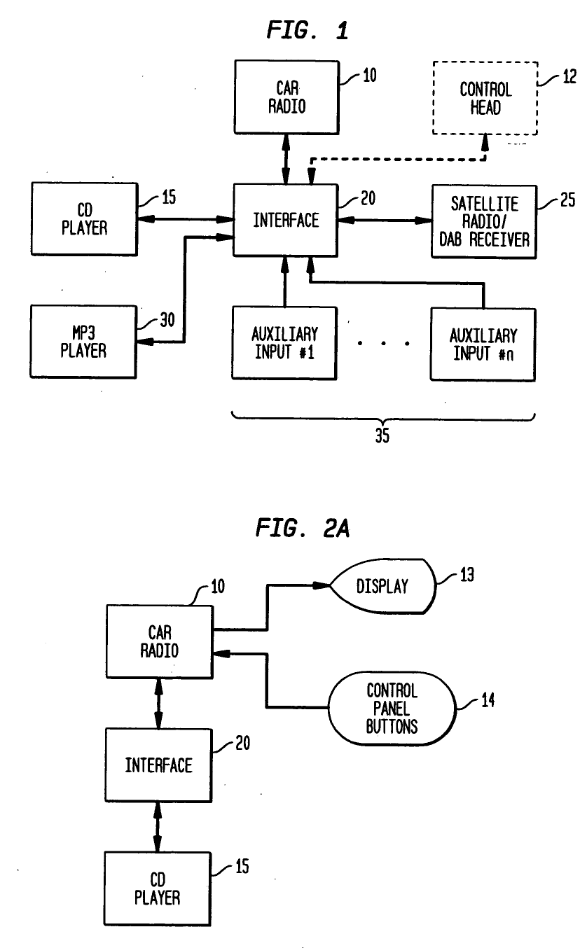

FIG. 1 is a block diagram showing the audio device integration (or interface) system of the present invention, generally indicated at 20. A plurality of devices and auxiliary inputs can be connected to the interface 20, and integrated with an OEM or after-market car radio 10. A CD player or changer 15 can be integrated with the radio 10 via interface 20. A satellite radio or DAB receiver 25, such as an XM radio satellite receiver or DAB receiver known in the art, could be integrated with the radio 10, via the interface 20. Further, an MP3 player could also be integrated with the radio 10 via interface 20. Moreover, a plurality of auxiliary input sources, illustratively indicated as auxiliary input sources 35 (comprising input sources 1 through n, n being any number), could also be integrated with the car radio 10 via interface 20. Optionally, a control head 12, such as that commonly used with after-market CD changers and other similar devices, could be integrated with the car radio 10 via interface 20, for controlling any of the car radio 10, CD player/changer 15, satellite/DAB receiver 25, MP3 player 30, and auxiliary input sources 35. Thus, as can be readily appreciated, the interface 20 of the present invention allows for the integration of a multitude of devices and inputs with an OEM or after-market car radio or stereo.

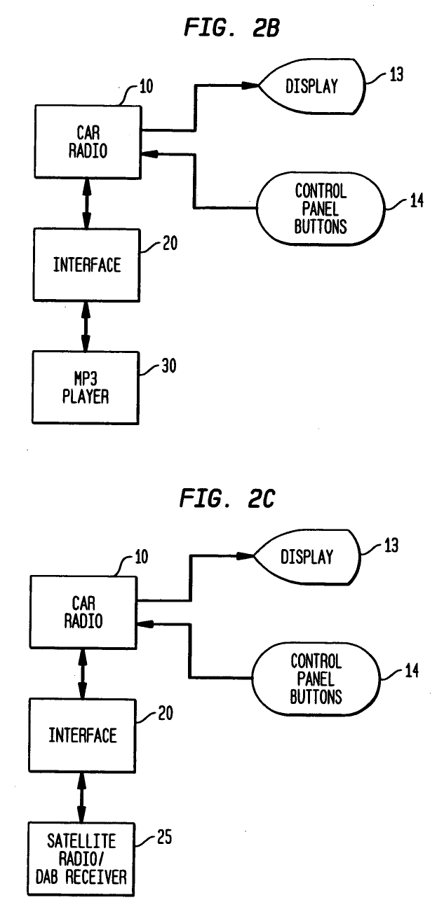

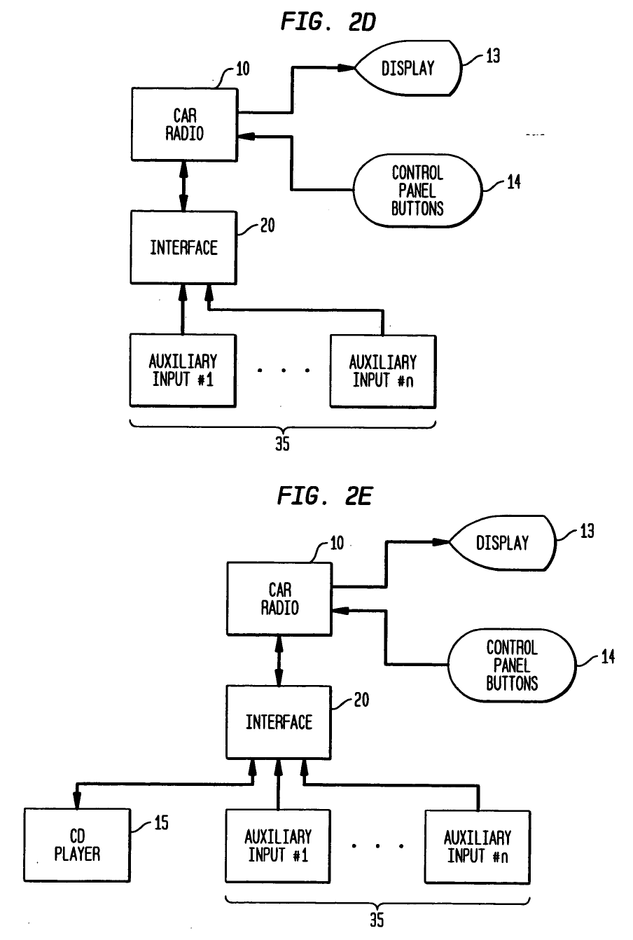

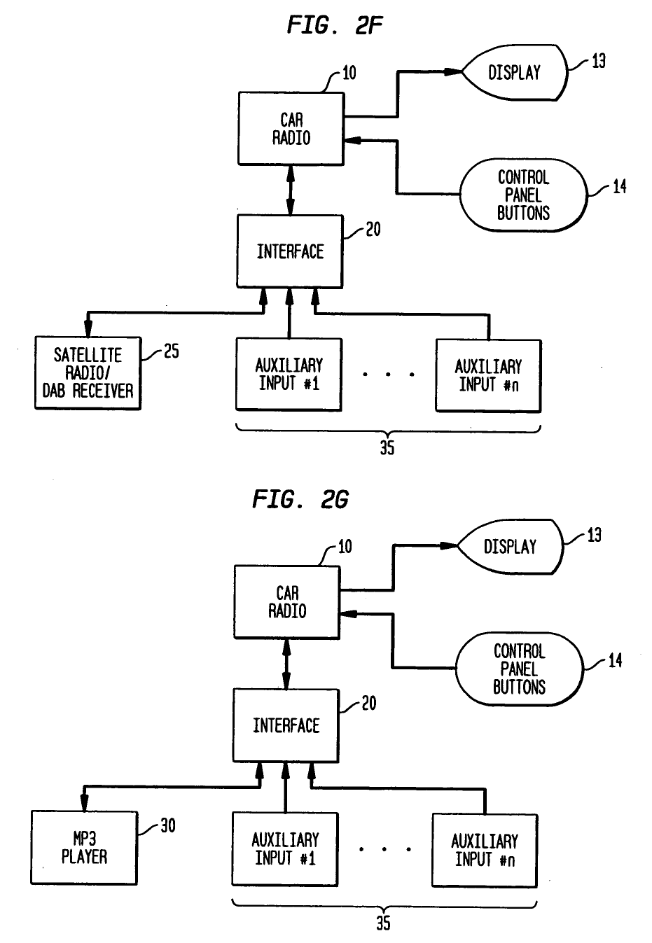

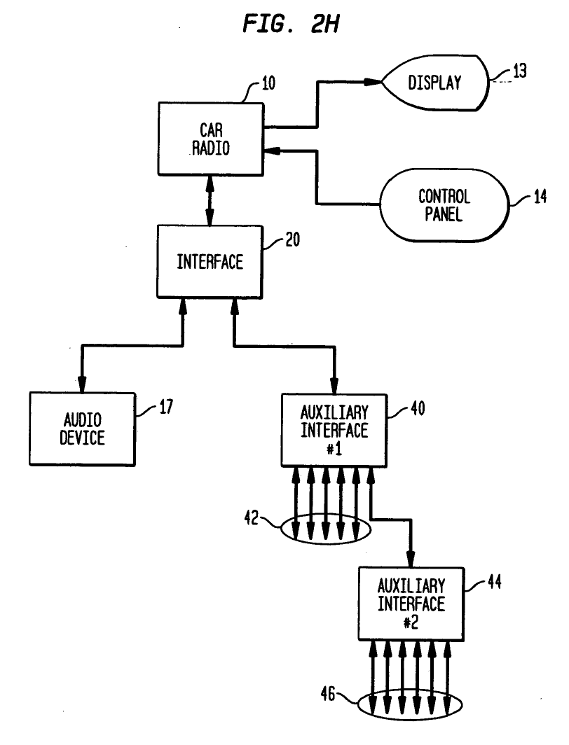

FIG. 2a is a block diagram of an alternate embodiment of the audio device interface system of the present invention, wherein a CD player/changer 15 is integrated with an OEM or after-market car radio 10. The CD player 15 is electrically connected with the interface 20, and exchanges data and audio signals therewith. The interface 20 is electrically connected with the car radio 10, and exchanges data and audio signals therewith. In a preferred embodiment of the present invention, the car radio 10 includes a display 13 (such as an alphanumeric, electroluminescent display) for displaying information, and a plurality of control panel buttons 14 that normally operate to control the radio 10. The interface 20 allows the CD player 15 to be controlled by the control buttons 14 of the radio 10. Further, the interface 20 allows information from the CD player 15, such as track, disc, time, and song information, to be retrieved therefrom, processed and formatted by the interface 20, sent to the display 13 of the radio 10.

Importantly, the interface 20 allows for the remote control of the CD player 15 from the radio 10 (e.g., the CD player 15 could be located in the trunk of a car, while the radio 10 is mounted on the dashboard of the car). Thus, for example, one or more discs stored within the CD player 15 can be remotely selected by a user from the radio 10, and tracks on one or more of the discs can be selected therefrom. Moreover, standard CD operational commands, such as pause, play, stop, fast forward, rewind, track forward, and track reverse (among other commands) can be remotely entered at the control panel buttons 14 of the radio 10 for remotely controlling the CD player 15.

FIG. 2b is a block diagram showing an alternate embodiment of the present invention, wherein an MP3 player 30 is integrated with an OEM or after-market car radio 10 via interface 20. As mentioned earlier, the interface 20 of the present invention allows for a plurality of disparate audio devices to be integrated with an existing car radio for use therewith. Thus, as shown in FIG. 2b, remote control of the MP3 player 30 via radio 10 is provided for via interface 20. The MP3 player 30 is electronically interconnected with the interface 20, which itself is electrically interconnected with the car radio 10. The interface 20 allows data and audio signals to be exchanged between the MP3 player 30 and the car radio 10, and processes and formats signals accordingly so that instructions and data from the radio 10 are processable by the MP3 player 30, and vice versa. Operational commands, such as track selection, pause, play, stop, fast forward, rewind, and other commands, are entered via the control panel buttons 14 of car radio 10, processed by the interface 20, and formatted for execution by the MP3 player 30. Data from the MP3 player, such as track, time, and song information, is received by the interface 20, processed thereby, and sent to the radio 10 for display on display 13. Audio from the MP3 player 30 is selectively forwarded by the interface 20 to the radio 10 for playing.

FIG. 2c is a block diagram showing an alternate embodiment of the present invention, wherein a satellite receiver or DAB receiver 25 is integrated with an OEM or after-market car radio 10 via the interface 20. Satellite/DAB receiver 25 can be any satellite radio receiver known in the art, such as XM or Sirius, or any DAB receiver known in the art. The satellite/DAB receiver 25 is electrically interconnected with the interface 20, which itself is electrically interconnected with the car radio 10. The satellite/DAB receiver 25 is remotely operable by the control panel buttons 14 of the radio 10. Commands from the radio 10 are received by the interface 20, processed and formatted thereby, and dispatched to the satellite/DAB receiver 25 for execution thereby. Information from the satellite/DAB receiver 25, including time, station, and song information, is received by the interface 20, processed, and transmitted to the radio 10 for display on display 13. Further, audio from the satellite/DAB receiver 25 is selectively forwarded by the interface 20 for playing by the radio 10.

FIG. 2d is a block diagram showing an alternate embodiment of the present invention, wherein one or more auxiliary input sources 35 are integrated with an OEM or after-market car radio 10. The auxiliary inputs 35 can be connected to analog sources, or can be digitally coupled with one or more audio devices, such as after-market CD players, CD changers, MP3 players, satellite receivers, DAB receivers, and the like, and integrated with an existing car stereo. Preferably, four auxiliary input sources are connectable with the interface 20, but any number of auxiliary input sources could be included. Audio from the auxiliary input sources 35 is selectively forwarded to the radio 10 under command of the user. As will be discussed herein in greater detail, a user can select a desired input source from the auxiliary input sources 35 by depressing one or more of the control panel buttons 14 of the radio 10. The interface 20 receives the command initiated from the control panel, processes same, and connects the corresponding input source from the auxiliary input sources 35 to allow audio therefrom to be forwarded to the radio 10 for playing. Further, the interface 20 determines the type of audio devices connected to the auxiliary input ports 35, and integrates same with the car stereo 10.

As mentioned previously, the present invention allows one or more external audio devices to be integrated with an existing OEM or after-market car stereo, along with one or more auxiliary input sources, and the user can select between these sources using the controls of the car stereo. Such “dual input” capability allows operation with devices connected to either of the inputs of the device, or both. Importantly, the device can operate in “plug and play” mode, wherein any device connected to one of the inputs is automatically detected by the present invention, its device type determined, and the device automatically integrated with an existing OEM or after-market car stereo. Thus, the present invention is not dependent any specific device type to be connected therewith to operate. For example, a user can first purchase a CD changer, plug same into a dual interface, and use same with the car stereo. At a point later in time, the user could purchase an XM tuner, plug same into the device, and the tuner will automatically be detected and integrated with the car stereo, allowing the user to select from and operate both devices from the car stereo. It should be noted that such plug and play capability is not limited to a dual input device, but is provided for in every embodiment of the present invention. The dual-input configuration of the preset invention is illustrated in FIGS. 2e-2h and described below.

FIG. 2e is a block diagram showing an alternate embodiment of the present invention, wherein an external CD player/changer 15 and one or more auxiliary input sources 35 are integrated with an OEM or after-market car stereo 10. Both the CD player 15 and one or more of the auxiliary input sources 35 are electrically interconnected with the interface 20, which, in turn, is electrically interconnected to the radio 10. Using the controls 14 of the radio 10, a user can select between the CD player 15 and one or more of the inputs 35 to selectively channel audio from these sources to the radio. The command to select from one of these sources is received by the interface 20, processed thereby, and the corresponding source is channeled to the radio 10 by the interface 20. As will be discussed later in greater detail, the interface 20 contains internal processing logic for selecting between these sources.

FIG. 2f is a block diagram of an alternate embodiment of the present invention, wherein a satellite receiver or DAB receiver and one or more auxiliary input sources are integrated by the interface 20 with an OEM or after-market car radio 10. Similar to the embodiment of the present invention illustrated in FIG. 2e and described earlier, the interface 20 allows a user to select between the satellite/DAB receiver 25 and one or more of the auxiliary input sources 35 using the controls 14 of the radio 10. The interface 20 contains processing logic, described in greater detail below, for allowing switching between the satellite/DAB receiver 25 and one or more of the auxiliary input sources 35.

FIG. 2g is a block diagram of an alternate embodiment of the present invention, wherein a MP3 player 30 and one or more auxiliary input sources 35 are integrated by the interface 20 with an OEM or after-market car radio 10. Similar to the embodiments of the present invention illustrated in FIGS. 2e and 2f and described earlier, the interface 20 allows a user to select between the MP3 player 30 and one or more of the auxiliary input sources 35 using the controls 14 of the radio 10. The interface 20 contains processing logic, as will be discussed later in greater detail, for allowing switching between the MP3 player 30 and one or more of the auxiliary input sources 35.

FIG. 2h is a block diagram showing an alternate embodiment of the present invention, wherein a plurality of auxiliary interfaces 40 and 44 and an audio device 17 are integrated with an OEM or after-market car stereo 10. Importantly, the present invention can be expanded to allow a plurality of auxiliary inputs to be connected to the car stereo 10 in a tree-like fashion. Thus, as can be seen in FIG. 2h, a first auxiliary interface 40 is connected to the interface 20, and allows data and audio from the ports 42 to be exchanged with the car radio 10. Connected to one of the ports 42 is another auxiliary interface 44, which, in turn, provides a plurality of input ports 46. Any device connected to any of the ports 42 or 46 can be integrated with the car radio 10. Further, any device connected to the ports 42 or 46 can be inter-operable with the car radio 10, allowing commands to be entered from the car radio 10 (e.g., such as via the control panel 14) for commanding the device, and information from the device to be displayed by the car radio 10. Conceivably, by configuring the interfaces 40, 44, and successive interfaces in a tree configuration, any number of devices can be integrated using the present invention.

The various embodiments of the present invention described above and shown in FIGS. 1 through 2h are illustrative in nature and are not intended to limit the spirit or scope of the present invention. Indeed, any conceivable audio device or input source, in any desired combination, can be integrated by the present invention into existing car stereo systems. Further, it is conceivable that not only can data and audio signals be exchanged between the car stereo and any external device, but also video information that can be captured by the present invention, processed thereby, and transmitted to the car stereo for display thereby and interaction with a user thereat.

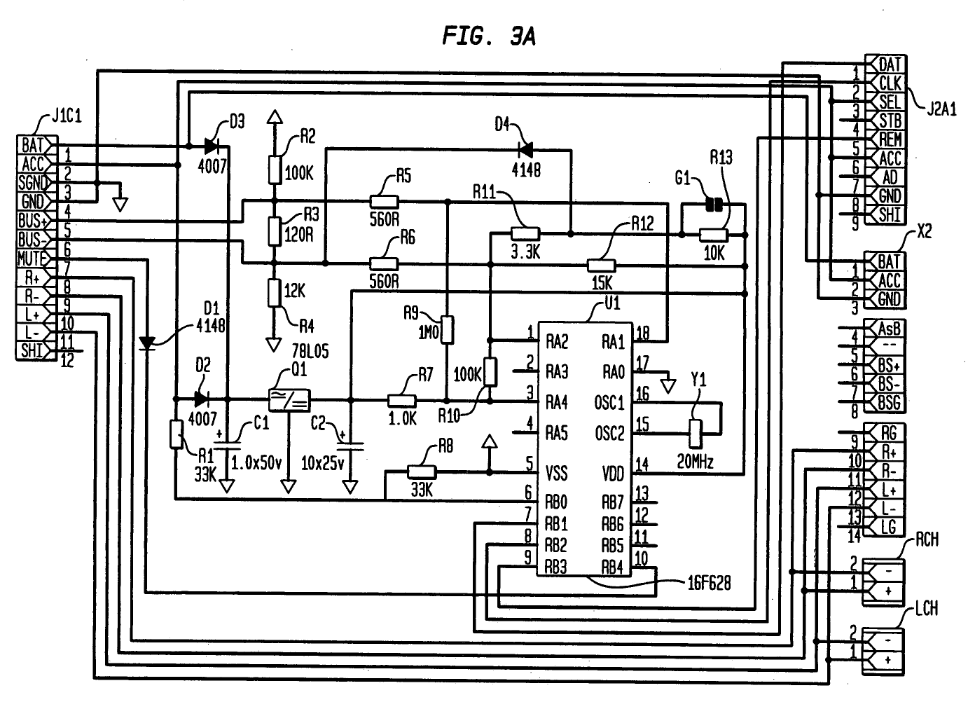

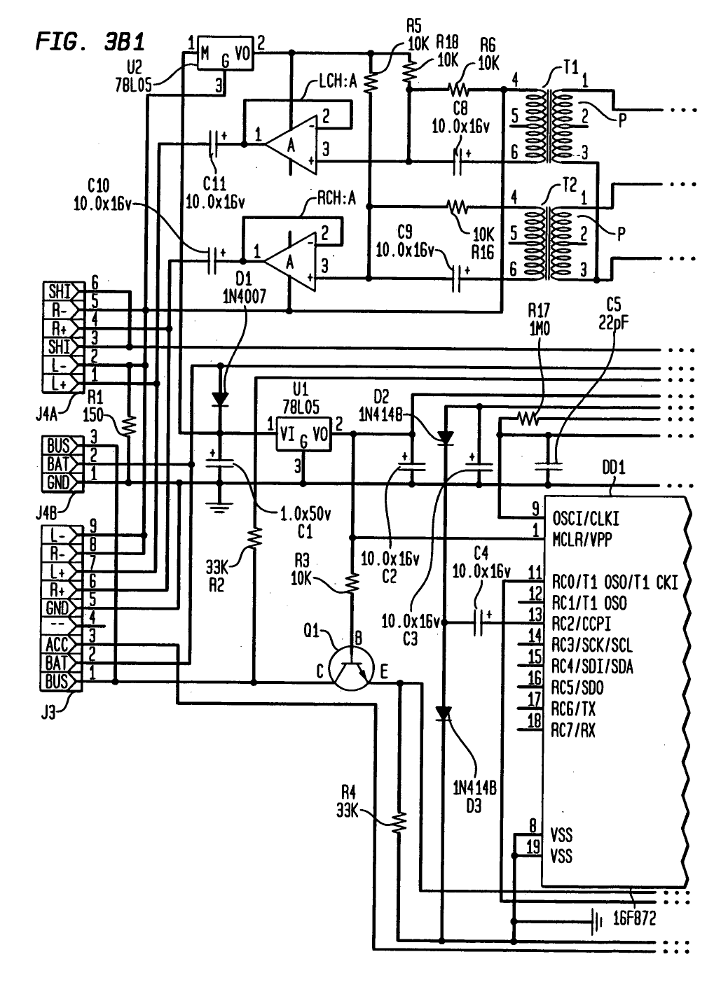

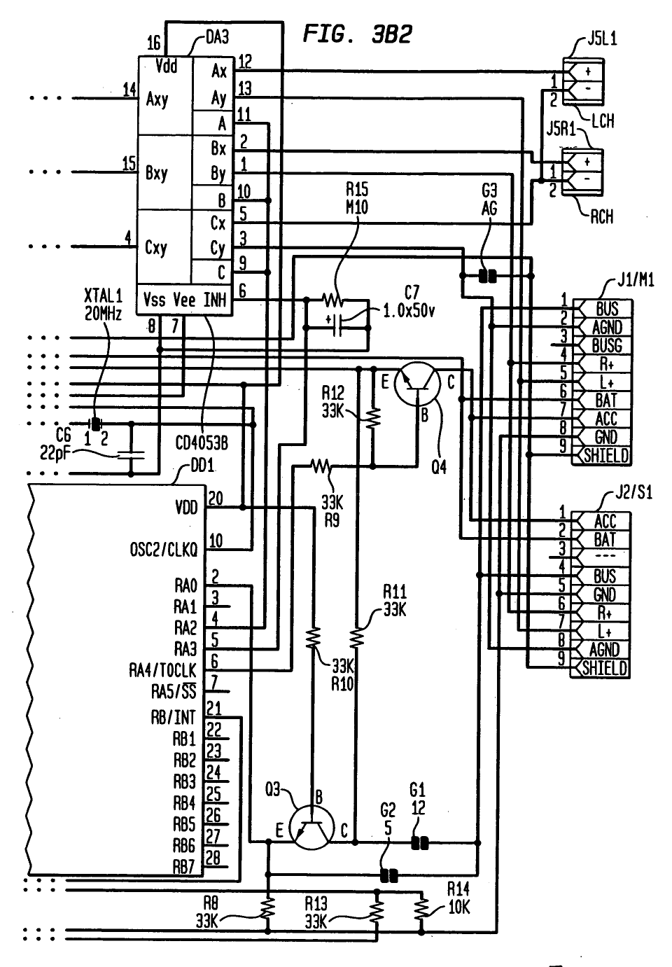

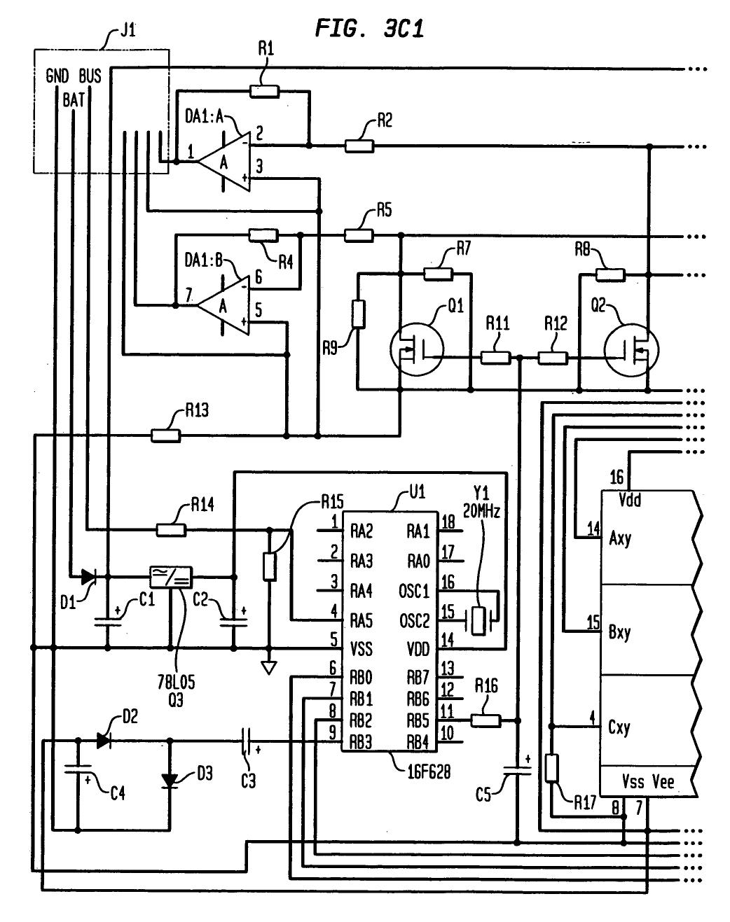

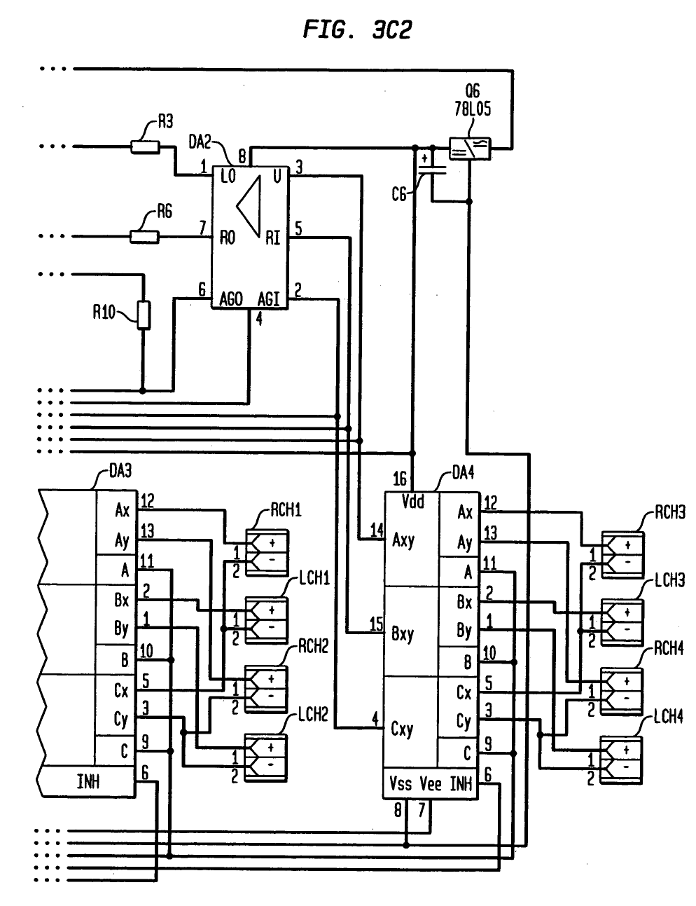

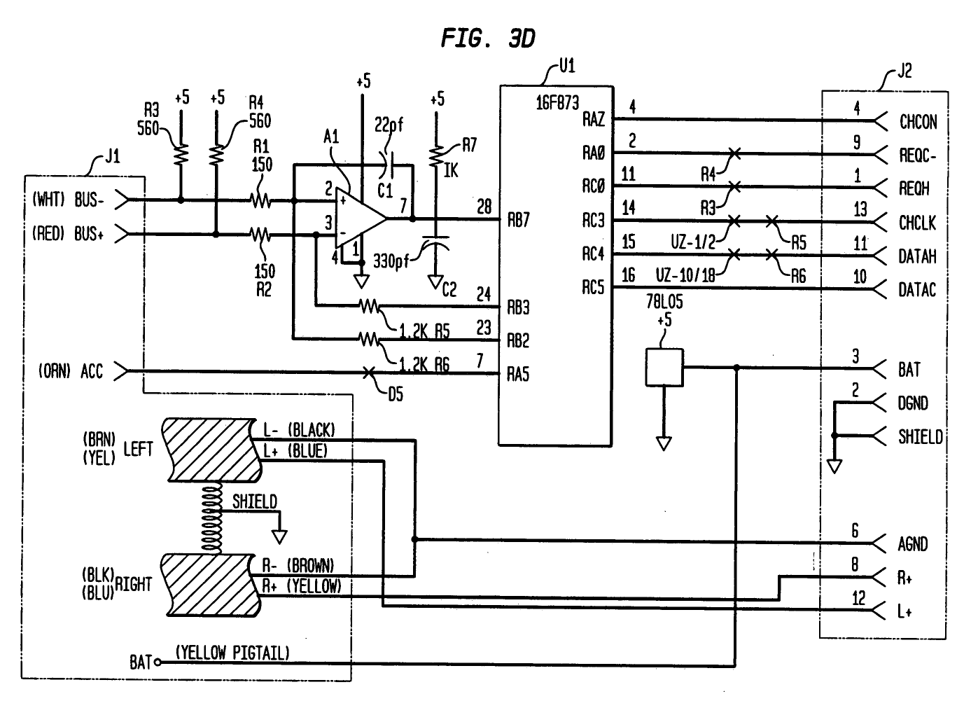

Various circuit configurations can be employed to carry out the present invention. Examples of such configurations are described below and shown in FIGS. 3a-3d.

FIG. 3a is an illustrative circuit diagram according to the present invention for integrating a CD player or an auxiliary input source with an existing car stereo system. A plurality of ports J1C1, J2A1, X2, RCH, and LCH are provided for allowing connection of the interface system of the present invention between an existing car radio, an after-market CD player or changer, or an auxiliary input source. Each of these ports could be embodied by any suitable electrical connector known in the art. Port J1C1 connects to the input port of an OEM car radio, such as that manufactured by TOYOTA, Inc. Conceivably, port J1C1 could be modified to allow connection to the input port of an after-market car radio. Ports J2A1, X2, RCH, and LCH connect to an after-market CD changer, such as that manufactured by PANASONIC, Inc., or to an auxiliary input source.

Microcontroller U1 is in electrical communication with each of the ports J1C1, J2A1, and X2, and provides functionality for integrating the CD player or auxiliary input source connected to the ports J2A1, X2, RCH, and LCH. For example, microcontroller U1 receives control commands, such as button or key sequences, initiated by a user at control panel of the car radio and received at the connector J1C1, processes and formats same, and dispatches the formatted commands to the CD player or auxiliary input source via connector J2A1. Additionally, the microcontroller U1 receives information provided by the CD player or auxiliary input source via connector J2A1, processes and formats same, and transmits the formatted data to the car stereo via connector J1C1 for display on the display of the car stereo. Audio signals provided at the ports J2A1, X2, RCH and LCH is selectively channeled to the car radio at port J1C1 under control of one or more user commands and processing logic, as will be discussed in greater detail, embedded within microcontroller U1.

In a preferred embodiment of the present invention, the microcontroller U1 comprises the 16F628 microcontroller manufactured by MICROCHIP, Inc. The 16F628 chip is a CMOS, flash-based, 8-bit microcontroller having an internal, 4 MHz internal oscillator, 128 bytes of EEPROM data memory, a capture/compare/PWM, a USART, 2 comparators, and a programmable voltage reference. Of course, any suitable microcontroller known in the art can be substituted for microcontroller U1 without departing from the spirit or scope of the present invention.

A plurality of discrete components, such as resistors R1 through R13, diodes D1 through D4, capacitors C1 and C2, and oscillator Y1, among other components, are provided for interfacing the microcontroller U1 with the hardware connected to the connectors J1C1, J2A1, X2, RCH, and LCH. These components, as will be readily appreciated to one of ordinary skill in the art, can be arranged as desired to accommodate a variety of microcontrollers, and the numbers and types of discrete components can be varied to accommodate other similar controllers. Thus, the circuit shown in FIG. 3a and described herein is illustrative in nature, and modifications thereof are considered to be within the spirit and scope of the present invention.

FIG. 3b is a diagram showing an illustrative circuit configuration according to the present invention, wherein one or more after-market CD changers/players and an auxiliary input source are integrated with an existing car stereo, and wherein the user can select between the CD changer/player and the auxiliary input using the controls of the car stereo. A plurality of connectors are provided, illustratively indicated as ports J4A, J4B, J3, J5L1, J5R1, J1, and J2. Ports J4A, J4B, and J3 allow the audio device interface system of the present invention to be connected to one or more existing car stereos, such as an OEM car stereo or an after-market car stereo. Each of these ports could be embodied by any suitable electrical connector known in the art. For example, ports J4A and J4B can be connected to an OEM car stereo manufactured by BMW, Inc. Port J3 can be connected to a car stereo manufactured by LANDROVER, Inc. Of course, any number of car stereos, by any manufacturer, could be provided. Ports J1 and J2 allow connection to an after-market CD changer or player, such as that manufactured by ALPINE, Inc., and an auxiliary input source. Optionally, ports J5L1 and J5R1 allow integration of a standard analog (line-level) source. Of course, a single standalone CD player or auxiliary input source could be connected to either of ports J1 or J2.

Microcontroller DD1 is in electrical communication with each of the ports J4A, J4B, J3, J5L1, J5R1, J1, and J2, and provides functionality for integrating the CD player and auxiliary input source connected to the ports J1 and J2 with the car stereo connected to the ports J4A and J4B or J3. For example, microcontroller DD1 receives control commands, such as button or key sequences, initiated by a user at control panel of the car radio and received at the connectors J4A and J4B or J3, processes and formats same, and dispatches the formatted commands to the CD player and auxiliary input source via connectors J1 or J2. Additionally, the microcontroller DD1 receives information provided by the CD player and auxiliary input source via connectors J1 or J2, processes and formats same, and transmits the formatted data to the car stereo via connectors J4A and J4B or J3 for display on the display of the car stereo. Further, the microcontroller DD1 controls multiplexer DA3 to allow selection between the CD player/changer and the auxiliary input. Audio signals provided at the ports J1, J2, J5L1 and J5R1 is selectively channeled to the car radio at ports J4A and J4B or J3 under control of one or more user commands and processing logic, as will be discussed in greater detail, embedded within microcontroller DD1.

In a preferred embodiment of the present invention, the microcontroller DD1 comprises the 16F872 microcontroller manufactured by MICROCHIP, Inc. The 16F872 chip is a CMOS, flash-based, 8-bit microcontroller having 64 bytes of EEPROM data memory, self-programming capability, an ICD, 5 channels of 10 bit Analog-to-Digital (A/D) converters, 2 timers, capture/compare/PWM functions, a USART, and a synchronous serial port configurable as either a 3-wire serial peripheral interface or a 2-wire inter-integrated circuit bus. Of course, any suitable microcontroller known in the art can be substituted for microcontroller DD1 without departing from the spirit or scope of the present invention. Additionally, in a preferred embodiment of the present invention, the multiplexer DA3 comprises the CD4053 triple, two-channel analog multiplexer/demultiplexer manufactured by FAIRCHILD SEMICONDUCTOR, Inc. Any other suitable multiplexer can be substituted for DA3 without departing from the spirit or scope of the present invention.

A plurality of discrete components, such as resistors R1 through R18, diodes D1 through D3, capacitors C1-C11, and G1-G3, transistors Q1-Q3, transformers T1 and T2, amplifiers LCH:A and LCH:B, oscillator XTAL1, among other components, are provided for interfacing the microcontroller DD1 and the multiplexer DA3 with the hardware connected to the connectors J4A, J4B, J3, J5L1, J5R1, J1, and J2. These components, as will be readily appreciated to one of ordinary skill in the art, can be arranged as desired to accommodate a variety of microcontrollers and multiplexers, and the numbers and types of discrete components can be varied to accommodate other similar controllers and multiplexers. Thus, the circuit shown in FIG. 3b and described herein is illustrative in nature, and modifications thereof are considered to be within the spirit and scope of the present invention.

FIG. 3c is a diagram showing an illustrative circuit configuration for integrating a plurality of auxiliary inputs using the controls of the car stereo. A plurality of connectors are provided, illustratively indicated as ports J1, RCH1, LCH1, RCH2, LCH2, RCH3, LCH3, RCH4, and LCH4. Port J1 allows the audio device integration system of the present invention to be connected to one or more existing car stereos. Each of these ports could be embodied by any suitable electrical connector known in the art. For example, port J1 could be connected to an OEM car stereo manufactured by HONDA, Inc., or any other manufacturer. Ports RCH1, LCH1, RCH2, LCH2, RCH3, LCH3, RCH4, and LCH4 allow connection with the left and right channels of four auxiliary input sources. Of course, any number of auxiliary input sources and ports/connectors could be provided.

Microcontroller U1 is in electrical communication with each of the ports J1, RCH1, LCH1, RCH2, LCH2, RCH3, LCH3, RCH4, and LCH4, and provides functionality for integrating one or more auxiliary input sources connected to the ports RCH1, LCH1, RCH2, LCH2, RCH3, LCH3, RCH4, and LCH4 with the car stereo connected to the port J1. Further, the microcontroller U1 controls multiplexers DA3 and DA4 to allow selection amongst any of the auxiliary inputs using the controls of the car stereo. Audio signals provided at the ports RCH1, LCH1, RCH2, LCH2, RCH3, LCH3, RCH4, and LCH4 are selectively channeled to the car radio at port J1 under control of one or more user commands and processing logic, as will be discussed in greater detail, embedded within microcontroller U1. In a preferred embodiment of the present invention, the microcontroller U1 comprises the 16F872 microcontroller discussed earlier. Additionally, in a preferred embodiment of the present invention, the multiplexers DA3 and DA4 comprises the CD4053 triple, two-channel analog multiplexer/demultiplexer, discussed earlier. Any other suitable microcontroller and multiplexers can be substituted for U1, DA3, and DA4 without departing from the spirit or scope of the present invention.

A plurality of discrete components, such as resistors R1 through R15, diodes D1 through D3, capacitors C1-C5, transistors Q1-Q2, amplifiers DA1:A and DA1:B, and oscillator Y1, among other components, are provided for interfacing the microcontroller U1 and the multiplexers DA3 and DA4 with the hardware connected to the ports J1, RCH1, LCH1, RCH2, LCH2, RCH3, LCH3, RCH4, and LCH4. These components, as will be readily appreciated to one of ordinary skill in the art, can be arranged as desired to accommodate a variety of microcontrollers and multiplexers, and the numbers and types of discrete components can be varied to accommodate other similar controllers and multiplexers. Thus, the circuit shown in FIG. 3c and described herein is illustrative in nature, and modifications thereof are considered to be within the spirit and scope of the present invention.

FIG. 3d is an illustrative circuit diagram according to the present invention for integrating a satellite receiver with an existing OEM or after-market car stereo system. Ports J1 and J2 are provided for allowing connection of the integration system of the present invention between an existing car radio and a satellite receiver. These ports could be embodied by any suitable electrical connector known in the art. Port J2 connects to the input port of an existing car radio, such as that manufactured by KENWOOD, Inc. Port 1 connects to an after-market satellite receiver, such as that manufactured by PIONEER, Inc.

Microcontroller U1 is in electrical communication with each of the ports J1 and J2, and provides functionality for integrating the satellite receiver connected to the port J1 with the car stereo connected to the port J2. For example, microcontroller U1 receives control commands, such as button or key sequences, initiated by a user at control panel of the car radio and received at the connector J2, processes and formats same, and dispatches the formatted commands to the satellite receiver via connector J2. Additionally, the microcontroller U1 receives information provided by the satellite receiver via connector J1, processes and formats same, and transmits the formatted data to the car stereo via connector J2 for display on the display of the car stereo. Audio signals provided at the port J1 is selectively channeled to the car radio at port J2 under control of one or more user commands and processing logic, as will be discussed in greater detail, embedded within microcontroller U1.

In a preferred embodiment of the present invention, the microcontroller U1 comprises the 16F873 microcontroller manufactured by MICROCHIP, Inc. The 16F873 chip is a CMOS, flash-based, 8-bit microcontroller having 128 bytes of EEPROM data memory, self-programming capability, an ICD, 5 channels of 10 bit Analog-to-Digital (A/D) converters, 2 timers, 2 capture/compare/PWM functions, a synchronous serial port that can be configured as a either a 3-wire serial peripheral interface or a 2-wire inter-integrated circuit bus, and a USART. Of course, any suitable microcontroller known in the art can be substituted for microcontroller U1 without departing from the spirit or scope of the present invention.

A plurality of discrete components, such as resistors R1 through R7, capacitors C1 and C2, and amplifier A1, among other components, are provided for interfacing the microcontroller U1 with the hardware connected to the connectors J1 and J2. These components, as will be readily appreciated to one of ordinary skill in the art, can be arranged as desired to accommodate a variety of microcontrollers, and the numbers and types of discrete components can be varied to accommodate other similar controllers. Thus, the circuit shown in FIG. 3d and described herein is illustrative in nature, and modifications thereof are considered to be within the spirit and scope of the present invention.

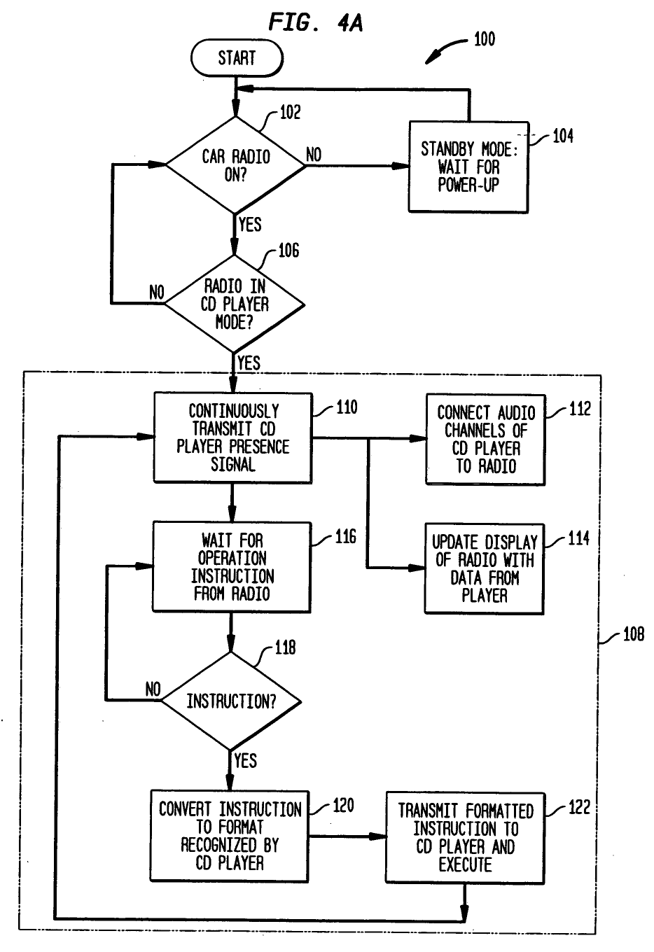

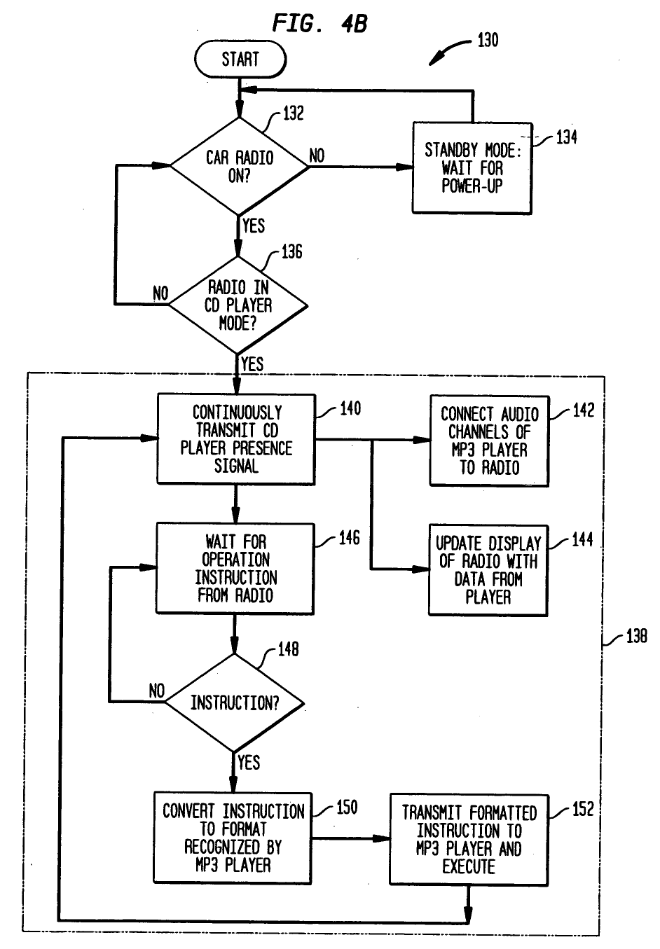

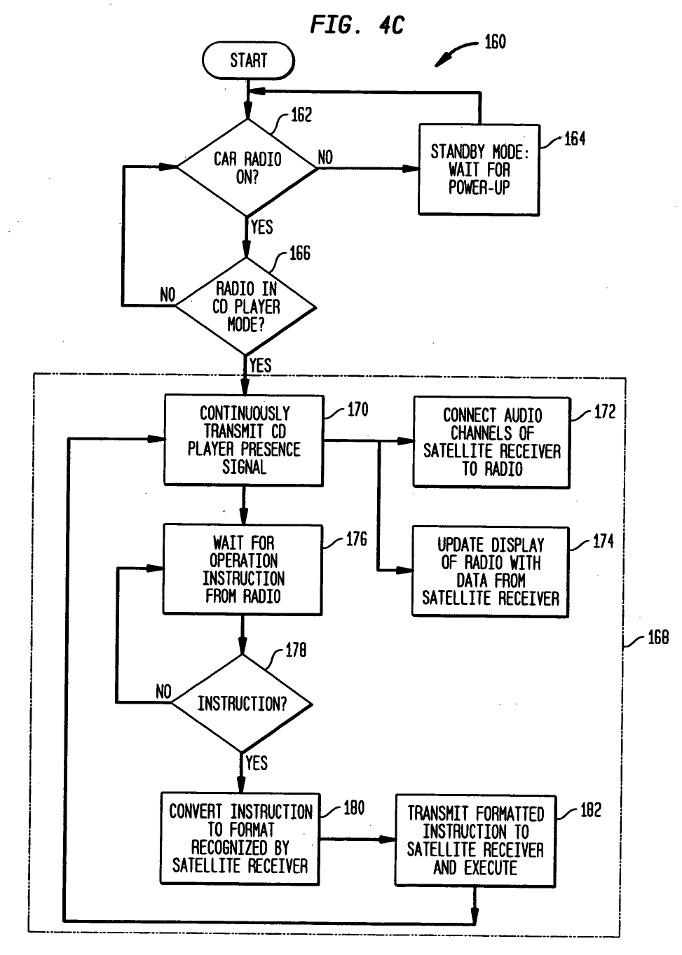

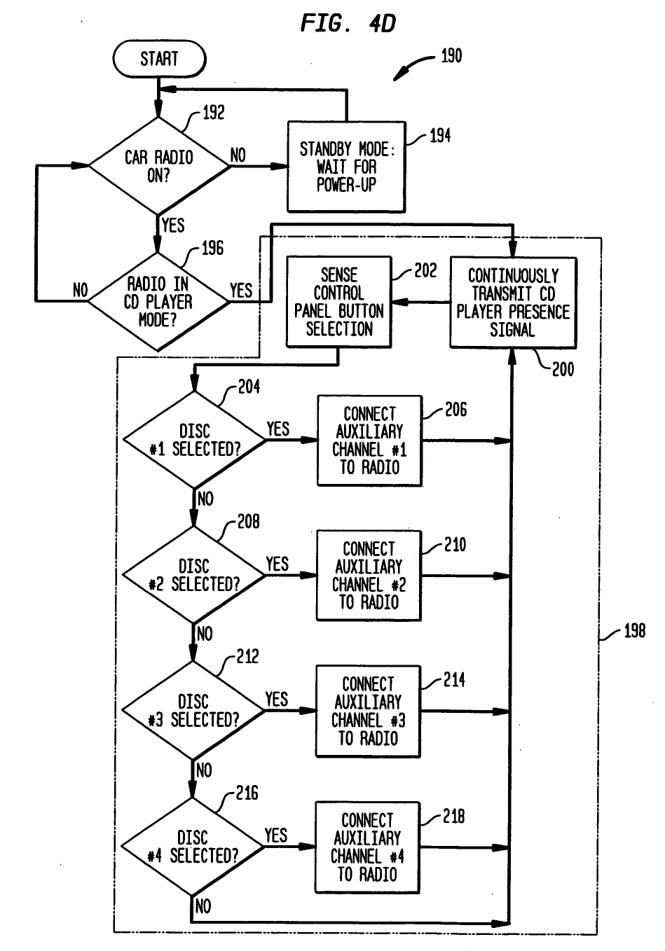

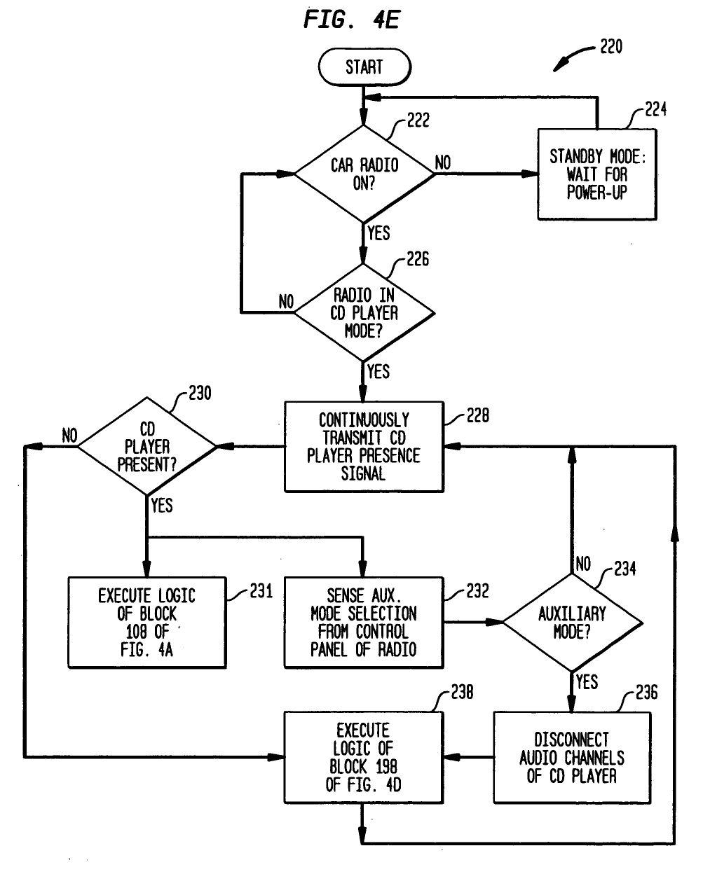

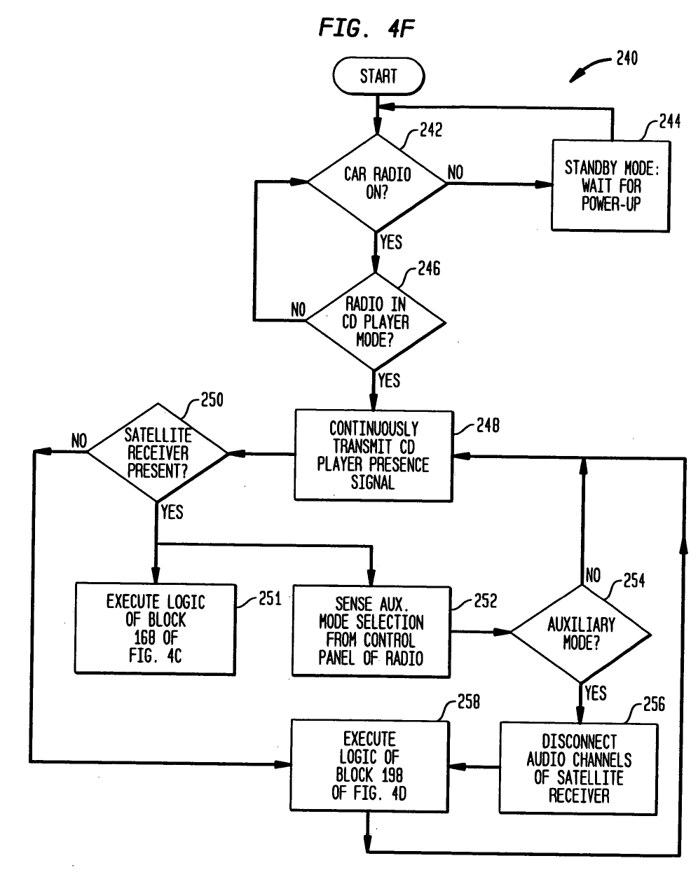

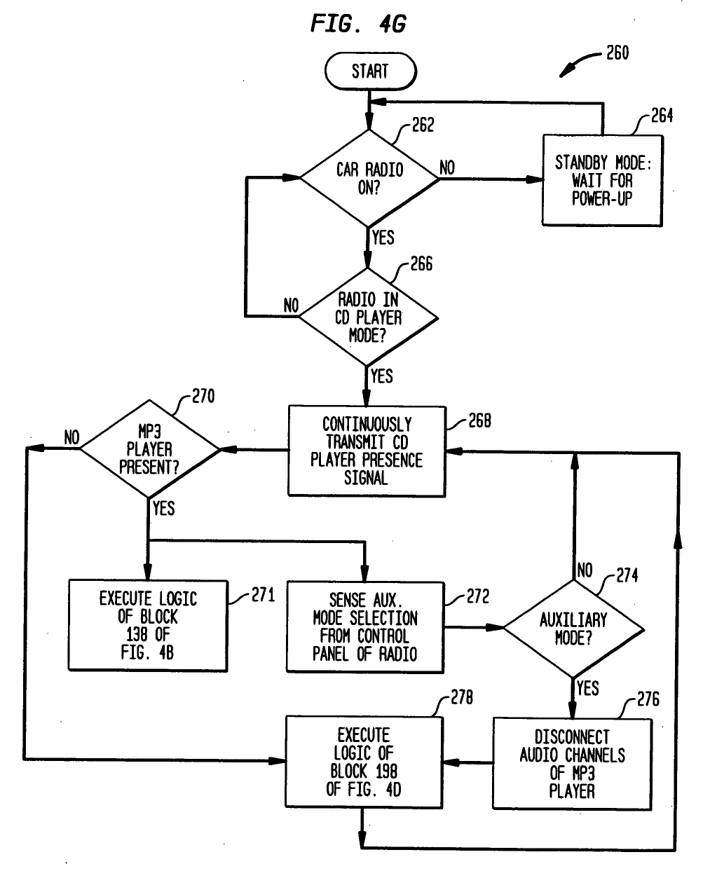

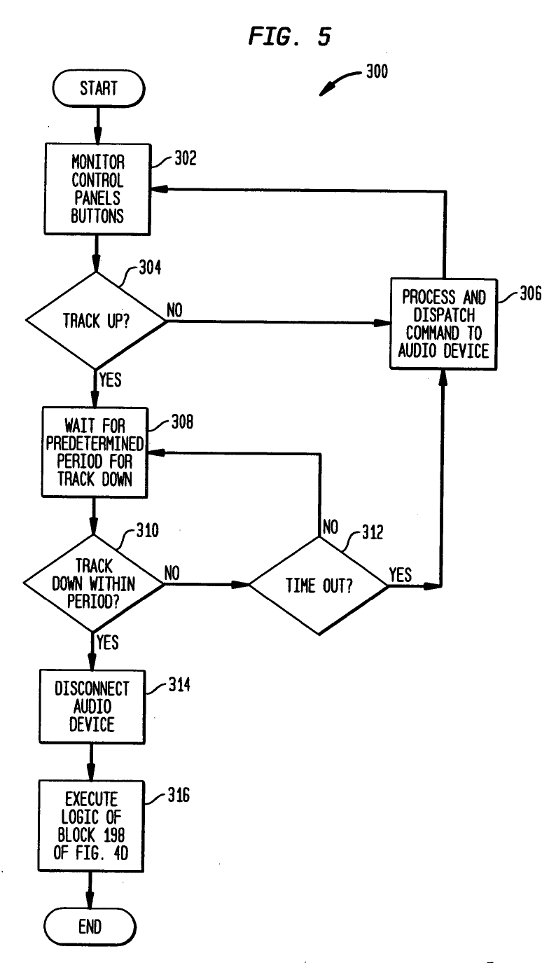

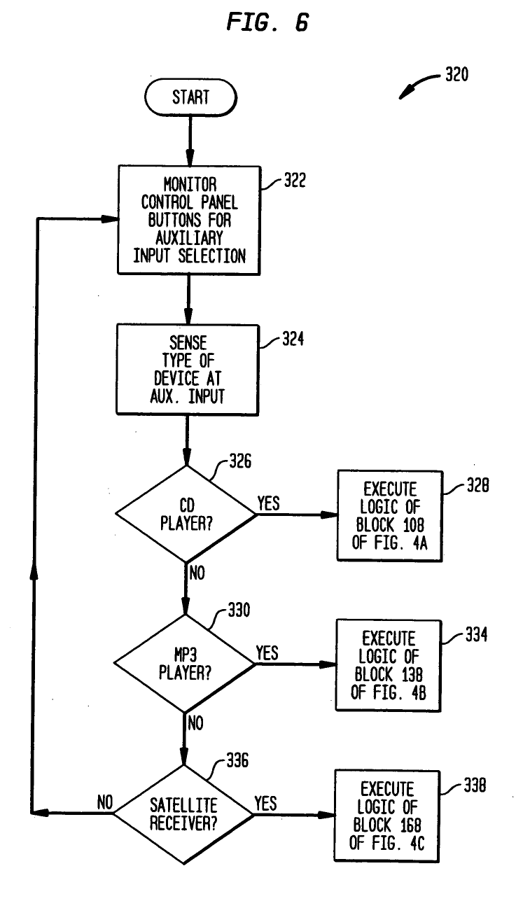

FIGS. 4a through 6 are flowcharts showing processing logic according to the present invention. Such logic can be embodied as software and/or instructions stored in a read-only memory circuit (e.g., and EEPROM circuit), or other similar device. In a preferred embodiment of the present invention, the processing logic described herein is stored in one or more microcontrollers, such as the microcontrollers discussed earlier with reference to FIGS. 3a-3d. Of course, any other suitable means for storing the processing logic of the present invention can be employed.

FIG. 4a is a flowchart showing processing logic, indicated generally at 100, for integrating a CD player or changer with an existing OEM or after-market car stereo system. Beginning in step 100, a determination is made as to whether the existing car stereo is powered on. If a negative determination is made, step 104 is invoked, wherein the present invention enters a standby mode and waits for the car stereo to be powered on. If a positive determination is made, step 106 is invoked, wherein a second determination is made as to whether the car stereo is in CD player mode. If a negative determination is made, step 106 is re-invoked.

If a positive determination is made in step 106, a CD handling process, indicated as block 108, is invoked, allowing the CD player/changer to exchange data and audio signals with any existing car stereo system. Beginning in step 110, a signal is generated by the present invention indicating that a CD player/changer is present, and the signal is continuously transmitted to the car stereo. Importantly, this signal prevents the car stereo from shutting off, entering a sleep mode, or otherwise being unresponsive to signals and/or data from an external source. If the car radio is an OEM car radio, the CD player presence signal need not be generated. Concurrently with step 110, or within a short period of time before or after the execution of step 110, steps 112 and 114 are invoked. In step 112, the audio channels of the CD player/changer are connected (channeled) to the car stereo system, allowing audio from the CD player/changer to be played through the car stereo. In step 114, data is retrieved by the present invention from the CD player/changer, including track and time information, formatted, and transmitted to the car stereo for display by the car stereo. Thus, information produced by the external CD player/changer can be quickly and conveniently viewed by a driver by merely viewing the display of the car stereo. After steps 110, 112, and 114 have been executed, control passes to step 116.

In steps 116, the present invention monitors the control panel buttons of the car stereo for CD operational commands. Examples of such commands include track forward, track reverse, play, stop, fast forward, rewind, track program, random track play, and other similar commands. In step 118, if a command is not detected, step 116 is re-invoked. Otherwise, if a command is received, step 118 invokes step 120, wherein the received command is converted into a format recognizable by the CD player/changer connected to the present invention. For example, in this step, a command issued from a GM car radio is converted into a format recognizable by a CD player/changer manufactured by ALPINE, Inc. Any conceivable command from any type of car radio can be formatted for use by a CD player/changer of any type or manufacture. Once the command has been formatted, step 122 is invoked, wherein the formatted command is transmitted to the CD player/changer and executed. Step 110 is then re-invoked, so that additional processing can occur.

FIG. 4b is a flowchart showing processing logic, indicated generally at 130, for integrating an MP3 player with an existing car stereo system. Beginning in step 132, a determination is made as to whether the existing car stereo is powered on. If a negative determination is made, step 134 is invoked, wherein the present invention enters a standby mode and waits for the car stereo to be powered on. If a positive determination is made, step 136 is invoked, wherein a second determination is made as to whether the car stereo is in CD player mode. If a negative determination is made, step 136 is re-invoked.

If a positive determination is made in step 136, an MP3 handling process, indicated as block 138, is invoked, allowing the MP3 player to exchange data and audio signals with any existing car stereo system. Beginning in step 140, the CD player presence signal, described earlier, is generated by the present invention and continuously transmitted to the car stereo. If the car radio is an OEM car radio, the CD player presence signal need not be generated. In step 142, the audio channels of the MP3 player are connected (channeled) to the car stereo system, allowing audio from the MP3 player to be played through the car stereo. In step 144, data is retrieved by the present invention from the MP3 player, including track, time, title, and song information, formatted, and transmitted to the car stereo for display by the car stereo. Thus, information produced by the MP3 player can be quickly and conveniently viewed by a driver by merely viewing the display of the car stereo. After steps 140, 142, and 144 have been executed, control passes to step 146.

In steps 146, the present invention monitors the control panel buttons of the car stereo for MP3 operational commands. Examples of such commands include track forward, track reverse, play, stop, fast forward, rewind, track program, random track play, and other similar commands. In step 148, if a command is not detected, step 146 is re-invoked. Otherwise, if a command is received, step 148 invokes step 150, wherein the received command is converted into a format recognizable by the MP3 player connected to the present invention. For example, in this step, a command issued from a HONDA car radio is converted into a format recognizable by an MP3 player manufactured by PANASONIC, Inc. Any conceivable command from any type of car radio can be formatted for use by an MP3 player of any type or manufacture. Once the command has been formatted, step 152 is invoked, wherein the formatted command is transmitted to the MP3 player and executed. Step 140 is then re-invoked, so that additional processing can occur.

FIG. 4c is a flowchart showing processing logic, indicated generally at 160, for integrating a satellite receiver or a DAB receiver with an existing car stereo system. Beginning in step 162, a determination is made as to whether the existing car stereo is powered on. If a negative determination is made, step 164 is invoked, wherein the present invention enters a standby mode and waits for the car stereo to be powered on. If a positive determination is made, step 166 is invoked, wherein a second determination is made as to whether the car stereo is in CD player mode. If a negative determination is made, step 166 is re-invoked.

If a positive determination is made in step 166, a satellite/DAB receiver handling process, indicated as block 168, is invoked, allowing the satellite/DAB receiver to exchange data and audio signals with any existing car stereo system. Beginning in step 170, the CD player presence signal, described earlier, is generated by the present invention and continuously transmitted to the car stereo. If the car radio is an OEM car radio, the CD player presence signal need not be generated. In step 172, the audio channels of the satellite/DAB receiver are connected (channeled) to the car stereo system, allowing audio from the satellite receiver or DAB receiver to be played through the car stereo. In step 174, data is retrieved by the present invention from the satellite/DAB receiver, including channel number, channel name, artist name, song time, and song title, formatted, and transmitted to the car stereo for display by the car stereo. The information could be presented in one or more menus, or via a graphical interface viewable and manipulable by the user at the car stereo. Thus, information produced by the receiver can be quickly and conveniently viewed by a driver by merely viewing the display of the car stereo. After steps 170, 172, and 174 have been executed, control passes to step 176.

In steps 176, the present invention monitors the control panel buttons of the car stereo for satellite/DAB receiver operational commands. Examples of such commands include station up, station down, station memory program, and other similar commands. In step 178, if a command is not detected, step 176 is re-invoked. Otherwise, if a command is received, step 178 invokes step 180, wherein the received command is converted into a format recognizable by the satellite/DAB receiver connected to the present invention. For example, in this step, a command issued from a FORD car radio is converted into a format recognizable by a satellite receiver manufactured by PIONEER, Inc. Any conceivable command from any type of car radio can be formatted for use by a satellite/DAB receiver of any type or manufacture. Once the command has been formatted, step 182 is invoked, wherein the formatted command is transmitted to the satellite/DAB receiver and executed. Step 170 is then re-invoked, so that additional processing can occur.

FIG. 4d is a flowchart showing processing logic, indicated generally at 190, for integrating a plurality of auxiliary input sources with a car radio. Beginning in step 192, a determination is made as to whether the existing car stereo is powered on. If a negative determination is made, step 194 is invoked, wherein the present invention enters a standby mode and waits for the car stereo to be powered on. If a positive determination is made, step 196 is invoked, wherein a second determination is made as to whether the car stereo is in CD player mode. If a negative determination is made, step 196 is re-invoked.

If a positive determination is made in step 196, an auxiliary input handling process, indicated as block 198, is invoked, allowing one or more auxiliary inputs to be connected (channeled) to the car stereo. Further, if a plurality of auxiliary inputs exist, the logic of block 198 allows a user to select a desired input from the plurality of inputs. Beginning in step 200, the CD player presence signal, described earlier, is generated by the present invention and continuously transmitted to the car stereo. If the car radio is an OEM car radio, the CD player presence signal need not be generated. Then, in step 202, the control panel buttons of the car stereo are monitored.

In a preferred embodiment of the present invention, each of the one or more auxiliary input sources are selectable by selecting a CD disc number on the control panel of the car radio. Thus, in step 204, a determination is made as to whether the first disc number has been selected. If a positive determination is made, step 206 is invoked, wherein the first auxiliary input source is connected (channeled) to the car stereo. If a negative determination is made, step 208 is invoked, wherein a second determination is made as to whether the second disc number has been selected. If a positive determination is made, step 210 is invoked, wherein the second auxiliary input source is connected (channeled) to the car stereo. If a negative determination is made, step 212 is invoked, wherein a third determination is made as to whether the third disc number has been selected. If a positive determination is made, step 214 is invoked, wherein the third auxiliary input source is connected (channeled) to the car stereo. If a negative determination is made, step 216 is invoked, wherein a fourth determination is made as to whether the fourth disc number has been selected. If a positive determination is made, step 218 is invoked, wherein the fourth auxiliary input source is connected (channeled) to the car stereo. If a negative determination is made, step 200 is re-invoked, and the process disclosed for block 198 repeated. Further, if any of steps 206, 210, 214, or 218 are executed, then step 200 is re-invoked and block 198 repeated.

The process disclosed in block 198 allows a user to select from one of four auxiliary input sources using the control buttons of the car stereo. Of course, the number of auxiliary input sources connectable with and selectable by the present invention can be expanded to any desired number. Thus, for example, 6 auxiliary input sources could be provided and switched using corresponding selection key(s) or keystroke(s) on the control panel of the radio. Moreover, any desired keystroke, selection sequence, or button(s) on the control panel of the radio, or elsewhere, can be utilized to select from the auxiliary input sources without departing from the spirit or scope of the present invention.

FIG. 4e is a flowchart showing processing logic, indicated generally at 220, for integrating a CD player and one or more auxiliary input sources with a car radio. Beginning in step 222, a determination is made as to whether the existing car stereo is powered on. If a negative determination is made, step 224 is invoked, wherein the present invention enters a standby mode and waits for the car stereo to be powered on. If a positive determination is made, step 226 is invoked, wherein a second determination is made as to whether the car stereo is in CD player mode. If a negative determination is made, step 226 is re-invoked.

If a positive determination is made in step 226, then step 228 is invoked, wherein the CD player presence, signal, described earlier, is generated by the present invention and continuously transmitted to the car stereo. Then, in step 230, a determination is made as to whether a CD player is present (i.e., whether an external CD player or changer is connected to the audio device integration system of the present invention). If a positive determination is made, steps 231 and 232 are invoked. In step 231, the logic of block 108 of FIG. 4a (the CD handling process), described earlier, is invoked, so that the CD player/changer can be integrated with the car stereo and utilized by a user. In step 232, a sensing mode is initiated, wherein the present invention monitors for a selection sequence (as will be discussed in greater detail) initiated by the user at the control panel of the car stereo for switching from the external CD player/changer to one or more auxiliary input sources. Step 234 is then invoked, wherein a determination is made as to whether such a sequence has been initiated. If a negative determination is made, step 234 re-invokes step 228, so that further processing can occur. Otherwise, if a positive determination is made (i.e., the user desires to switch from the external CD player/changer to one of the auxiliary input sources), step 236 is invoked, wherein the audio channels of the CD player/changer are disconnected from the car stereo. Then, step 238 is invoked, wherein the logic of block 198 of FIG. 4d (the auxiliary input handling process), discussed earlier, is executed, allowing the user to select from one of the auxiliary input sources. In the event that a negative determination is made in step 230 (no external CD player/changer is connected to the present invention), then step 238 is invoked, and the system goes into auxiliary mode. The user can then select from one or more auxiliary input sources using the controls of the radio.

FIG. 4f is a flowchart showing processing logic, indicated generally at 240, for integrating a satellite receiver or DAB receiver and one or more auxiliary input sources with a car radio. Beginning in step 242, a determination is made as to whether the existing car stereo is powered on. If a negative determination is made, step 244 is invoked, wherein the present invention enters a standby mode and waits for the car stereo to be powered on. If a positive determination is made, step 246 is invoked, wherein a second determination is made as to whether the car stereo is in CD player mode. If a negative determination is made, step 246 is re-invoked.

If a positive determination is made in step 246, then step 248 is invoked, wherein the CD player presence signal, described earlier, is generated by the present invention and continuously transmitted to the car stereo. Then, in step 250, a determination is made as to whether a satellite receiver or DAB receiver is present (i.e., whether an external satellite receiver or DAB receiver is connected to the audio device integration system of the present invention). If a positive determination is made, steps 231 and 232 are invoked. In step 251, the logic of block 168 of FIG. 4c (the satellite/DAB receiver handling process), described earlier, is invoked, so that the satellite receiver can be integrated with the car stereo and utilized by a user. In step 252, a sensing mode is initiated, wherein the present invention monitors for a selection sequence (as will be discussed in greater detail) initiated by the user at the control panel of the car stereo for switching from the external satellite receiver to one or more auxiliary input sources. Step 254 is then invoked, wherein a determination is made as to whether such a sequence has been initiated. If a negative determination is made, step 254 re-invokes step 258, so that further processing can occur. Otherwise, if a positive determination is made (i.e., the user desires to switch from the external satellite/DAB receiver to one of the auxiliary input sources), step 256 is invoked, wherein the audio channels of the satellite receiver are disconnected from the car stereo. Then, step 258 is invoked, wherein the logic of block 198 of FIG. 4d (the auxiliary input handling process), discussed earlier, is executed, allowing the user to select from one of the auxiliary input sources. In the event that a negative determination is made in step 250 (no external satellite/DAB receiver is connected to the present invention), then step 258 is invoked, and the system goes into auxiliary mode. The user can then select from one or more auxiliary input sources using the controls of the radio.

FIG. 4g is a flowchart showing processing logic according to the present invention for integrating an MP3 player and one or more auxiliary input sources with a car stereo. Beginning in step 262, a determination is made as to whether the existing car stereo is powered on. If a negative determination is made, step 264 is invoked, wherein the present invention enters a standby mode and waits for the car stereo to be powered on. If a positive determination is made, step 266 is invoked, wherein a second determination is made as to whether the car stereo is in CD player mode. If a negative determination is made, step 266 is re-invoked.

If a positive determination is made in step 266, then step 268 is invoked, wherein the CD player presence signal, described earlier, is generated by the present invention and continuously transmitted to the car stereo. Then, in step 270, a determination is made as to whether an MP3 player is present (i.e., whether an external MP3 player is connected to the audio device integration system of the present invention). If a positive determination is made, steps 271 and 272 are invoked. In step 271, the logic of block 138 of FIG. 4b (the MP3 handling process), described earlier, is invoked, so that the CD player/changer can be integrated with the car stereo and utilized by a user. In step 272, a sensing mode is initiated, wherein the present invention monitors for a selection sequence (as will be discussed in greater detail) initiated by the user at the control panel of the car stereo for switching from the external CD player/changer to one or more auxiliary input sources. Step 274 is then invoked, wherein a determination is made as to whether such a sequence has been initiated. If a negative determination is made, step 274 re-invokes step 278, so that further processing can occur. Otherwise, if a positive determination is made (i.e., the user desires to switch from the external MP3 player to one of the auxiliary input sources), step 276 is invoked, wherein the audio channels of the MP3 player are disconnected from the car stereo. Then, step 278 is invoked, wherein the logic of block 198 of FIG. 4d (the auxiliary input handling process), discussed earlier, is executed, allowing the user to select from one of the auxiliary input sources. In the event that a negative determination is made in step 270 (no external MP3 player is connected to the present invention), then step 278 is invoked, and the system goes into auxiliary mode. The user can then select from one or more auxiliary input sources using the controls of the radio.

As mentioned previously, to enable integration, the present invention contains logic for converting command signals issued from an after-market or OEM car stereo into a format compatible with one or more external audio devices connected to the present invention. Such logic can be applied to convert any car stereo signal for use with any external device. For purposes of illustration, a sample code portion is shown in Table 1, below, for converting control signals from a BMW car stereo into a format understandable by a CD changer:

TABLE 1

| | |
|---|---|
| ; | =============================================== |
| ; | Radio requests changer to STOP (exit PLAY mode) |
| ; | Decoding 6805183801004C message |
| ; | =============================================== |

Encode_RD_stop_msg:

movlw 0x68
xorwf BMW_Recv_buff,W
skpz
return
movlw 0x05
xorwf BMW_Recv_buff+1,W
skpz
return
movlw 0x18
xorwf BMW_Recv_buff+2,W
skpz
return
movlw 0x38
xorwf BMW_Recv_buff+3,W
skpz
return
movlw 0x01
xorwf BMW_Recv_buff+4,W
skpz
return
tstf BMW_Recv_buff+5
skpz
return
movlw 0x4C
xorwf BMW_Recv_buff+6,W
skpz
return
bsf BMW_Recv_STOP_msg
return

The code portion shown in Table 1 receives a STOP command issued by a BMW stereo, in a format proprietary to BMW stereos. Preferably, the received command is stored in a first buffer, such as BMW_Recv_buff. The procedure “Encode_RD_stop_msg” repetitively applies an XOR function to the STOP command, resulting in a new command that is in a format compatible with the after-market CD player. The command is then stored in an output buffer for dispatching to the CD player.

Additionally, the present invention contains logic for retrieving information from an after-market audio device, and converting same into a format compatible with the car stereo for display thereby. Such logic can be applied to convert any data from the external device for display on the car stereo. For purposes of illustration, a sample code portion is shown in Table 2, below, for converting data from a CD changer into a format understandable by a BMW car stereo:

TABLE 2

| | |
|---|---|
| ; | ========================================= |
| ; | Changer replies with STOP confirmation |
| ; | Encoding 180A68390002003F0001027D message |
| ; | ========================================= |

Load_CD_stop_msg:

| | |
|---|---|
| movlw 0x18 | |
| movwf BMW_Send_buff | |
| movlw 0x0A | |
| movwf BMW_Send_buff+1 | |
| movlw 0x68 | |
| movwf BMW_Send_buff+2 | |
| movlw 0x39 | |
| movwf BMW_Send_buff+3 | |
| movlw 0x00 | ;current status_XX=00, power off |
| movwf BMW_Send_buff+4 | |
| movlw 0x02 | ;current status_YY=02, power off |
| movwf BMW_Send_buff+5 | |
| clrf BMW_Send_buff+6 | ;separate field, always =0 |
| movfw BMW_MM_stat | ;current status_MM , |
| | magazine config |
| movwf BMW_Send_buff+7 | |
| clrf BMW_Send_buff+8 | ;separate field, always =0 |
| movfw BMW_DD_stat | ;current status_DD , current disc |
| movwf BMW_Send_buff+9 | |
| movfw BMW_TT_stat | ;current status_TT , current track |
| movwf BMW_Send_buff+10 | |
| xorwf BMW_Send_buff+9,W | ;calculate check sum |
| xorwf BMW_Send_buff+8,W | |
| xorwf BMW_Send_buff+7,W | |
| xorwf BMW_Send_buff+6,W | |
| xorwf BMW_Send_buff+5,W | |
| xorwf BMW_Send_buff+4,W | |
| xorwf BMW_Send_buff+3,W | |
| xorwf BMW_Send_buff+2,W | |
| xorwf BMW_Send_buff+1,W | |
| xorwf BMW_Send_buff,W | |
| movwf BMW_Send_buff+11 | ;store check sum |
| movlw D‘12’ | ;12 bytes total |
| movwf BMW_Send_cnt | |
| bsf BMW_Send_on | ;ready to send |
| return | |

The code portion shown in Table 2 receives a STOP confirmation message from the CD player, in a format proprietary to the CD player. Preferably, the received command is stored in a first buffer, such as BMW_Send_buff. The procedure “Load_CD_stop_msg” retrieves status information, magazine information, current disc, and current track information from the CD changer, and constructs a response containing this information. Then, a checksum is calculated and stored in another buffer. The response and checksum are in a format compatible with the BMW stereo, and are ready for dispatching to the car stereo.

While the above code portions are shown using assembler language, it is to be expressly understood that any low or high level language known in the art, such as C or C++, could be utilized without departing from the spirit or scope of the invention. It will be appreciated that various other code portions can be developed for converting signals from any after-market or OEM car stereo for use by an after-market external audio device, and vice versa.

FIG. 5 is a flowchart showing processing logic, indicated generally at 300 for allowing a user to switch between an after-market audio device, and one or more auxiliary input sources. As was discussed earlier, the present invention allows a user to switch from one or more connected audio devices, such as an external CD player/changer, MP3 player, satellite receiver, DAB receiver, or the like, and activate one or more auxiliary input sources. A selection sequence, initiated by the user at the control panel of the car stereo, allows such switching. Beginning in step 302, the buttons of the control panel are monitored. In step 304, a determination is made as to whether a “Track Up” button or sequence has been initiated by the user. The “Track Up” button or sequence can for a CD player, MP3 player, or any other device. If a negative determination is made, step 306 is invoked, wherein the sensed button or sequence is processed in accordance with the present invention and dispatched to the external audio device for execution. Then, step 302 is re-invoked, so that additional buttons or sequences can be monitored.

In the event that a positive determination is made in step 304, step 308 is invoked, wherein the present invention waits for a predetermined period of time while monitoring the control panel buttons for additional buttons or sequences. In a preferred embodiment of the present invention, the predetermined period of time is 750 milliseconds, but of course, other time durations are considered within the spirit and scope of the present invention. In step 310, a determination is made as to whether the user has initiated a “Track Down” button or sequence at the control panel of the car stereo within the predetermined time period. The track down button or sequence can be for a CD player, MP3 player, or any other device. If a negative determination is made, step 312 is invoked. In step 312, a determination is made as to whether a timeout has occurred (e.g., whether the predetermined period of time has expired). If a negative determination is made, step 308 is re-invoked. Otherwise, is a positive determination is made, step 312 invokes step 306, so that any buttons or key sequences initiated by the user that are not a “Track Down” command are processed in accordance with the present invention and dispatched to the audio device for execution.

In the event that a positive determination is made in step 310 (a “Track Down” button or sequence has been initiated within the predetermined time period), then step 314 is invoked. In step 314, the audio channels of the audio device are disconnected, and then step 316 is invoked. In step 316, the logic of block 198 of FIG. 4d (the auxiliary input handling process), discussed earlier, is invoked, so that the user can select from one of the auxiliary input sources in accordance with the present invention. Thus, at this point in time, the system has switched, under user control, from the audio device to a desired auxiliary input. Although the foregoing description of the process 300 has been described with reference to “Track Up” and “Track Down” buttons or commands initiated by the user, it is to be expressly understood that any desired key sequence, keystroke, button depress, or any other action, can be sensed in accordance with the present invention and utilized for switching modes.

When operating in auxiliary mode, the present invention provides an indication on the display of the car stereo corresponding to such mode. For example, the CD number could be displayed as “1”, and the track number displayed as “99,” thus indicating to the user that the system is operating in auxiliary mode and that audio and data is being supplied from an auxiliary input source. Of course, any other indication could be generated and displayed on the display of the car stereo, such as a graphical display (e.g., an icon) or textual prompt.

FIG. 6 is a flowchart showing processing logic, indicated generally at 320, for determining and handling various device types connected to the auxiliary input ports of the invention. The present invention can sense device types connected to the auxiliary input ports, and can integrate same with the car stereo using the procedures discussed earlier. Beginning in step 322, the control panel buttons of the car stereo are monitored for a button or sequence initiated by the user corresponding to an auxiliary input selection (such as the disc number method discussed earlier with reference to FIG. 4d). In response to an auxiliary input selection, step 324 is invoked, wherein the type of device connected to the selected auxiliary input is sensed by the present invention. Then, step 326 is invoked.

In step 326, a determination is made as to whether the device connected to the auxiliary input is a CD player/changer. If a positive determination is made, step 328 is invoked, wherein the logic of block 108 of FIG. 4a (the CD handling process), discussed earlier, is executed, and the CD player is integrated with the car stereo. If a negative determination is made in step 326, then step 330 is invoked. In step 330, a determination is made as to whether the device connected to the auxiliary input is an MP3 player. If a positive determination is made, step 334 is invoked, wherein the logic of block 138 if FIG. 4b (the MP3 handling process), discussed earlier, is executed, and the MP3 player is integrated with the car stereo. If a negative determination is made in step 330, then step 336 is invoked. In step 336, a determination is made as to whether the device connected to the auxiliary input is a satellite receiver or a DAB receiver. If a positive determination is made, step 338 is invoked, wherein the logic of block 168 of FIG. 4c (the satellite/DAB receiver handling process), discussed earlier, is executed, and the satellite receiver is integrated with the car stereo. If a negative determination is made in step 336, step 322 is re-invoked, so that additional auxiliary input selections can be monitored and processed accordingly. Of course, process 320 can be expanded to allow other types of devices connected to the auxiliary inputs of the present invention to be integrated with the car stereo.

The present invention can be expanded for allowing video information generated by an external device to be integrated with the display of an existing OEM or after-market car stereo. In such a mode, the invention accepts RGB input signals from the external device, and converts same to composite signals. The composite signals are then forwarded to the car stereo for display thereby, such as on an LCD panel of the stereo. Further, information from the external device can be formatted and presented to the user in one or more graphical user interfaces or menus capable of being viewed and manipulated on the car stereo.

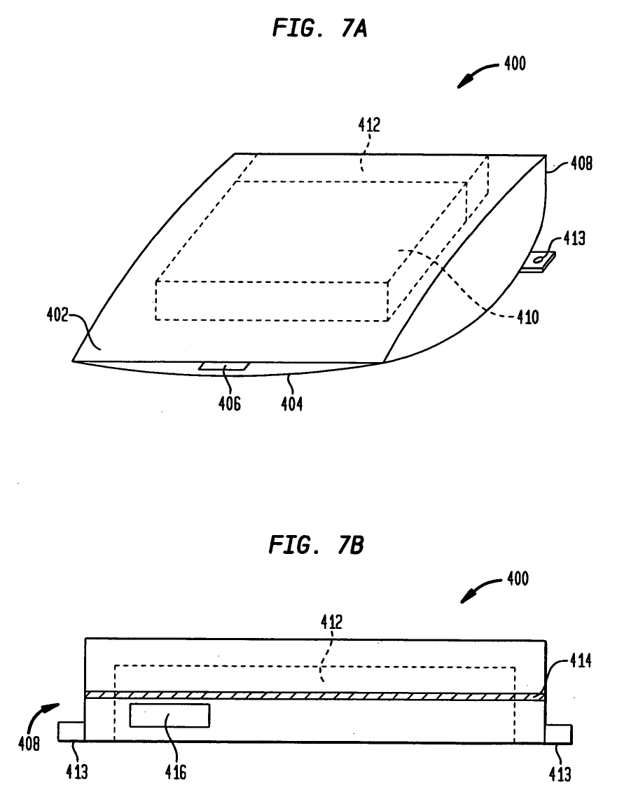

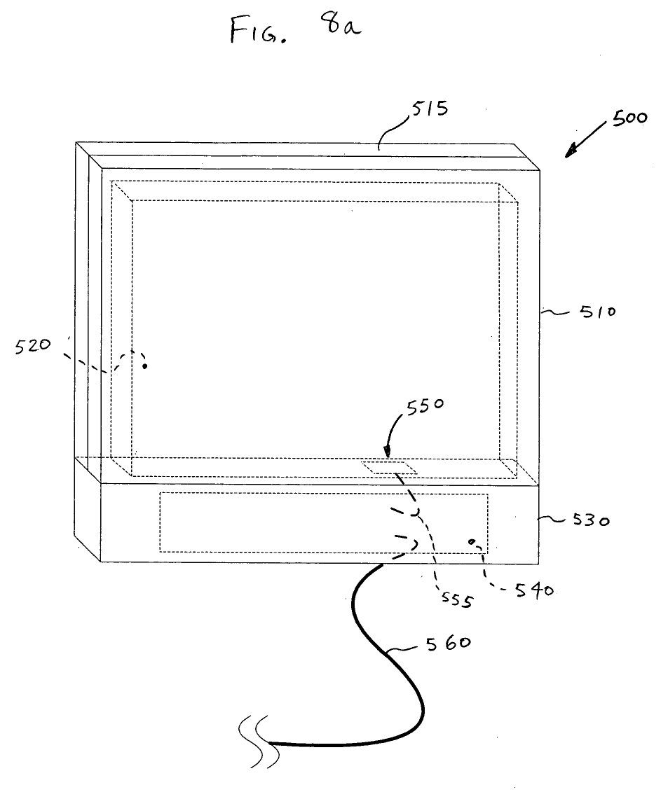

FIG. 7a is a perspective view of a docking station 400 according to the present invention for retaining an audio device within a car. Importantly, the present invention can be adapted to allow portable audio devices to be integrated with an existing car stereo. The docking station 400 allows such portable devices to be conveniently docked and integrated with the car stereo. The docking station 400 includes a top portion 402 hingedly connected at a rear portion 408 to a bottom portion 404, preferably in a clam-like configuration. A portable audio device 410, such as the SKYFI radio distributed by DELPHI, Inc., is physically and electrically connected with the docking portion 412, and contained within the station 100. A clasp 406 can be provided for holding the top and bottom portions in a closed position to retain the device 410. Optionally, a video device could also be docked using the docking station 400, and tabs 413 can be provided for holding the docking station 400 in place against a portion of a car. Conceivably, the docking station 400 could take any form, such as a sleeve-like device for receiving and retaining a portable audio device and having a docking portion for electrically and mechanically mating with the audio device.

FIG. 7b is an end view showing the rear portion 408 of the docking station 400 of FIG. 7a. A hinge 414 connects the top portion and the bottom portions of the docking station 400. A data port 416 is provided for interfacing with the audio device docked within the station 400, and is in electrical communication therewith. In a preferred embodiment of the present invention, the data port 416 is an RS-232 serial or USB data port that allows for the transmission of data with the audio device, and which connects with the audio device integration system of the present invention for integrating the audio device with an OEM or after-market car stereo. Any known bus technology can be utilized to interface with any portable audio or video device contained within the docking station 400, such as FIREWIRE, D2B, MOST, CAN, USB/USB2, IE Bus, T Bus, I Bus, or any other bus technology known in the art.

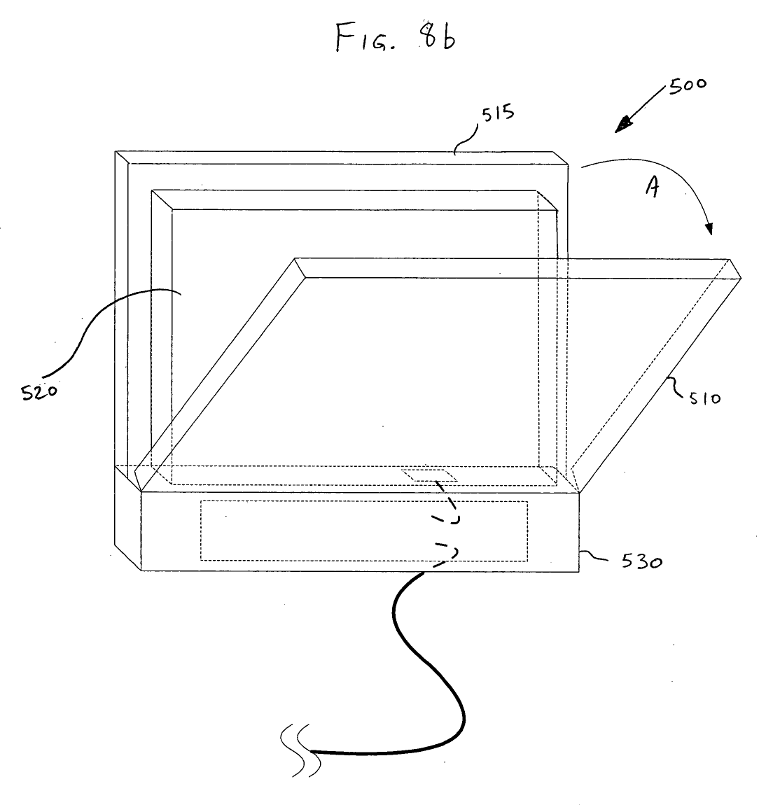

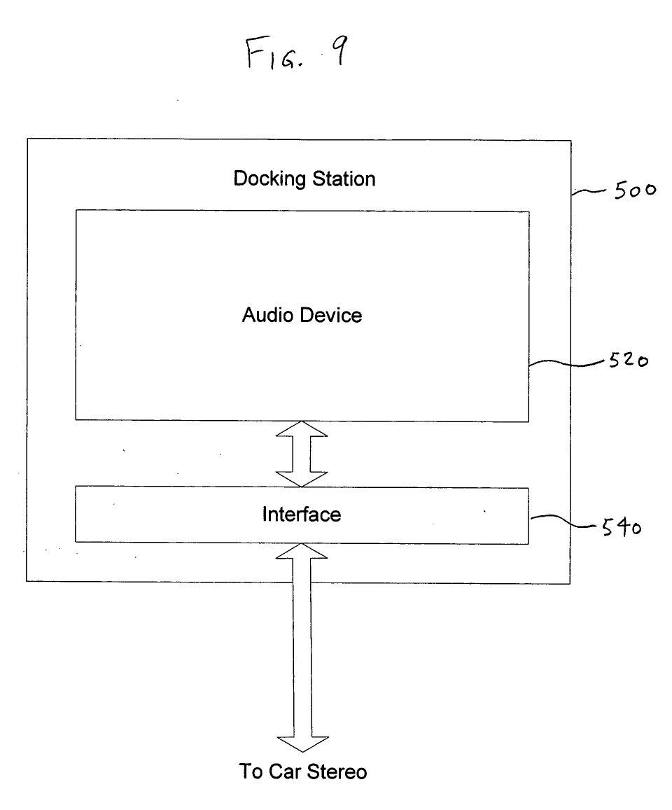

FIGS. 8a-8b are perspective views of another embodiment of the docking station of the present invention, indicated generally at 500, which includes the audio device integration system of the present invention, indicated generally at 540, incorporated therewith. As shown in FIG. 8a, the docking station 500 includes a base portion 530, a bottom member 515 interconnected with the base portion 530 at an edge thereof, and a top member 510 hingedly interconnected at an edge to the base portion 530. The top member 510 and the bottom member 515 define a cavity for docking and storing a portable audio device 520, which could be a portable CD player, MP3 player, satellite (e.g., XM, SIRIUS, or other type) tuner, or any other portable audio device. The docking station 500 would be configured to accommodate a specific device, such as an IPOD from Apple Computer, Inc., or any other portable device.

The audio device integration system 540, in the form of a circuit board, is housed within the base portion 530 and performs the integration functions discussed herein for integrating the portable audio device 520 with an existing car stereo. The integration system 540 is in communication with the portable audio device 520 via a connector 550, which is connected to a port on the audio device 520, and a cable 555 interconnected between the connector 550 and the integration system 540. The connector 550 could be any suitable connector and can vary according to the device type. For example, a MOLEX, USB, or any other connector could be used, depending on the portable device. The integration system 540 is electrically connected with a car stereo by cable 560. Alternatively, the integration system could wirelessly communicate with the car stereo. A transmitter could be used at the integration system to communicate with a receiver at the car stereo. Where automobiles include Bluetooth systems, such systems can be used to communicate with the integration system. As can be readily appreciated, the docking station 500 provides a convenient device for docking, storing, and integrating a portable audio device for use with a car stereo. Further, the docking station 500 could be positioned at any desired location within a vehicle, including, but not limited to, the vehicle trunk.

As shown in FIG. 8b, the top member 510 can be opened in the general direction indicated by arrow A to allow for access to the portable audio device 520. In this fashion, the device 520 can be quickly accessed for any desired purpose, such as for inserting and removing the device 520 from the docking station 500, as well as for providing access to the controls of the device 520.

FIG. 9 is a block diagram showing the components of the docking station of FIGS. 8a-8b. The docking station 500 houses both a portable audio device 520 and an audio device integration system (or interface) 540. The shape and configuration of the docking station 500 can be varied as desired without departing from the spirit or scope of the present invention.

The integration system of the present invention provides for control of a portable audio device, or other device, through the controls of the car stereo system. As such, controls on the steering wheel, where present, may also be used to control the portable audio device or other device.

Having thus described the invention in detail, it is to be understood that the foregoing description is not intended to limit the spirit and scope thereof.

What is claimed is:

1. A docking station for docking and integrating a portable audio device for use with a car stereo, comprising:
a base portion;
a bottom member connected to the base portion;
a top member connected to the base portion, the base portion, bottom member, and top member defining a cavity for receiving a portable device; and
an integration device positioned within the base portion for integrating the portable device with a car stereo.

2. The apparatus of claim 1, wherein the top member is hingedly connected at an edge to the base portion.

3. The apparatus of claim 1, wherein the base portion comprises a connector for connecting the integration device with the portable device.

4. The apparatus of claim 1, further comprising a cable interconnected at one end to the integration device and at an opposite end to the car stereo.

5. The apparatus of claim 1, wherein the integration device is wirelessly connected to the car stereo.

6. The apparatus of claim 5, wherein the integration device is connected to the car stereo by a Bluetooth wireless connection.

7. The apparatus of claim 1, wherein the portable device comprises a CD player, CD changer, MP3 player, Digital Audio Broadcast (DAB) receiver, or satellite receiver.

8. The apparatus of claim 7, wherein the satellite tuner comprises an XM or SIRIUS satellite tuner.

9. The apparatus of claim 1, wherein the integration device comprises a circuit board housed in the base portion.

10. The apparatus of claim 1, wherein the apparatus is mountable in a vehicle trunk.

11. The apparatus of claim 1, wherein the top member is pivotable away from the bottom member to allow access to the portable device.

12. The apparatus of claim 1, wherein the integration device is connected to the car stereo using a Firewire, D2B, MOST, CAN, USB, USB2, IE Bus, T Bus, I Bus, or serial connection.

13. The apparatus of claim 1, wherein the car stereo is an OEM or after-market car stereo.

14. The apparatus of claim 1, further comprising one or more auxiliary input ports connected to the integration device for integrating additional portable devices external to the docking station.

15. A method for docking and integrating a portable audio device for use with a car stereo, comprising:
providing a docking station having a base portion, a bottom member connected to the base portion, a top member connected to the base portion, and an integration device housed within the base portion;
inserting a portable device into the docking station and connecting the portable device to a connector on the base portion; and
integrating the portable device with the integration device for use with a car stereo.

16. The method of claim 15, further comprising opening the top member away from the bottom member prior to inserting the portable device into the docking station.

17. The method of claim 15, further comprising closing the top member to retain the portable device in the docking station.

18. The method of claim 15, further comprising interconnecting the integration device with the car stereo with a cable.

19. The method of claim 15, further comprising establishing a wireless connection between the integration device and the car stereo.

20. The method of claim 19 further comprising establishing a Bluetooth wireless connection between the integration device and the car stereo.

21. The method of claim 15, further comprising integrating a CD player, CD changer, MP3 player, Digital Audio Broadcast (DAB) receiver, or satellite receiver with the car stereo.

22. The method of claim 15, further comprising integrating an XM or SIRIUS satellite tuner with the car stereo.

23. The method of claim 15, further comprising mounting the docking station in a vehicle trunk.

24. The method of claim 15, further comprising connecting the integration device to the car stereo using a Firewire, D2B, MOST, CAN, USB, USB2, IE Bus, T Bus, I Bus, or serial connection.

25. The method of claim 15, further comprising integrating the portable device with an after-market or OEM car stereo.

26. The method of claim 15, further comprising connecting an external portable device to an auxiliary input port on the docking station and integrating the external portable device with the car stereo.
